(19) United States
(12) Patent Application Publication
(10) Pub. No.: US 2014/0215718 A1
(43) Pub. Date: Aug. 7, 2014

(54) OPERATING TABLES AND ACCESSORIES

(71) Applicant: Malcolm Wootton, Derbyshire (GB)

(72) Inventor: Malcolm Wootton, Derbyshire (GB)

(21) Appl. No.: 14/342,438

(22) PCT Filed: Sep. 6, 2012
(86) PCT No.: PCT/GB2012/052197

§ 371 Date: Apr. 11, 2014

(30) Foreign Application Priority Data
Sep. 6, 2011 (GB) 1115391.3
Oct. 19, 2011 (GB) 1118051.0

(51) Int. Cl. A61G 13/00; A61G 13/02; A61G 13/10; A61G 13/12

(52) U.S. Cl. CPC A61G 13/0036; A61G 13/1245; A61G 13/02; A61G 13/101; A61G 2013/0081; A61G 2200/327; A61G 2210/10
USPC 5/621; 5/630

(57) ABSTRACT

This application relates to operating tables and accessories designed to facilitate surgical procedures on a limb, especially, but not exclusively, orthopaedic procedures involving the distraction, dislocation or replacement of a joint. A such accessory includes a table-mounted component (200) including a patient support (103) and a floor-standing component (200) including an articulated limb support beam (205). Cooperating locating features including a notch 118 and guide channels (217) on the two components locate the components relative to each other. They are designed so that with the patient support (103) supporting at least some of the weight of the patient, the articulated limb support beam (205) is properly positioned to support and manipulate the limb. Moreover, they are so configured as to allow the table to be tilted relative to the floor-standing component (200) while continuing to locate the components relative to each other.

This application relates to several inventions concerning operating tables and accessories designed to facilitate surgical procedures on a limb, especially, but not exclusively, orthopaedic procedures involving the distraction, dislocation or replacement of a joint.

### BACKGROUND

Many of the inventions presented here were first conceived with reference to a particular surgical procedure. Whilst it has been realised that these inventions are of wider applicability than in the surgical procedure for which they were first conceived, it is nevertheless convenient to describe that procedure so that the reader can gain an understanding of the inventions in that context.

The procedure for which the inventions presented here were first conceived is a form of hip replacement surgery, known as “anterior approach” total hip replacement surgery. Whereas the majority of hip replacement surgeries are conducted through an incision in the side or the back of the hip, the anterior approach uses a small incision at the front of the hip. One advantage associated with this is that, postoperatively, the patient will not have to sit on the incision site, so convalescence is less painful. In addition, the anterior approach differs from the lateral or posterior approaches in that it does not require the major muscles of the hip, such as the gluteal muscles or the hip abductors, to be detached during the operation. Instead, the surgeon is able to work between the muscles from the front, thus sparing the soft tissues from trauma. The approach is known as a “tissue-sparing” procedure for this reason.

The incision site is determined using the anterior superior iliac spine as a reference. An incision is made close to the intermuscular space between the tensor fascia lata and the sartorius muscle. The fascia overlying the tensor fascia lata is then incised in line with the skin incision. The intermuscular space is enlarged by hand until the hip capsule can be felt. Using retractors on the hip abductors and the medial femoral neck, an anterior-superior capsulotomy is then performed to aid in visualization and femoral mobilization.

Next, an osteotomy of the femur is performed and, once the final neck cut has been made at the preoperatively planned osteotomy level, the femoral head can be twisted to rupture the ligamentum teres. This facilitates later dislocation of the joint. Distraction and external rotation of the leg can also be applied to create room for the removal of the femoral head.

With the femoral head removed, retractors are used to expose the acetabulum, which is then reamed and a new acetabular cup is implanted in the conventional way. The leg is then positioned in slight adduction and significant external rotation to expose the proximal femur. The femur is progressively lifted until the osteotomy plane can be reached through the skin incision. The femur can be lifted in a number of ways, such as manually with a bone hook.

A wedge of cancellous bone is removed from the cut end of the femur, creating an entry into the femoral canal. Broaching is then performed with progressive broach sizes, beginning with a smaller broach than the planned prosthesis. Once the final broach is in place, calcar planing can be performed, to remove bone protruding above the level of the impacted broach.

Next, a process of trial reduction is performed. The appropriate neck trial is placed in a hole on the upper face of the broach. An appropriate femoral head trial is selected and assembled for trial reduction. After components are selected, the hip is dislocated and the trial components are removed, along with the broach.

The appropriate femoral stem is chosen and placed into the prepared broach cavity. The femoral stem is impacted and another trial reduction can be performed with the final femoral stem and the femoral head trial. Next, the selected femoral head component is placed onto the taper of the femoral stem and secured using an impactor or, in the case of a ceramic head, by hand. The hip is reduced and a final check of leg length, and hip motion and stability should be made. The incision is then closed and the procedure is complete.

Evidence is now beginning to accumulate that the anterior approach enjoys a number of benefits as compared with the more conventional lateral or posterior approaches. Patients recover more quickly because their major muscles are not detached during the operation. Minimal muscle damage also means that there are fewer postoperative restrictions on joint mobility. The procedure helps patients to bend their hips more freely and to bear their full weight very soon after surgery. Scarring is reduced because of the use of a relatively small incision, and postoperative joint stability may be improved partly because the major muscles have not been disturbed.

In addition to these benefits, using the anterior approach, an incision is made closer to the hip joint and at a location where subcutaneous fat and other tissue layers are typically thinner than elsewhere. This means that more patients, particularly overweight patients, may be candidates for hip replacement surgery using this technique than with other techniques.

Operations of the complexity of total hip replacement, including the anterior approach, are seldom performed without the assistance of specifically designed or modified operating tables. The requirement to support, rotate, distract, adduct and otherwise manipulate the operative leg whilst continuing to support the weight of the patient means that such tables or accessories are seldom simple in design.

Such an operating table is briefly and incompletely described in US patent publication no. 2006/0064103 (“Matta”). The table is the “PRO fx” table manufactured by Orthopedic Systems, Inc., which also manufactures the “Hana” table for anterior approach total hip replacements. These tables each have leg supports that cantilever off an operating table at one end and are capable of being set down on the ground at their other end. Another specially designed operating table can be found in U.S. Pat. No. 6,286,164 (“Lamb”). Specially designed operating tables such as these tend to be extremely expensive, and for this reason some attention has been paid in the recent past to the design of accessories for pre-existing operating tables, which can be bolted up to the table when required and removed when they are no longer needed.

Possibly the simplest design of operating table accessory designed to facilitate surgery on a limb is described and illustrated in US patent publication no. 2010/0263129 (“Aboujaoude”). This is a device designed to be bolted up to the lateral accessory rail that is a universal feature of modern day operating tables, and to immobilise and position the leg. The device has a rail mount clamp that attaches to the operating table rail. A telescopic arm extends vertically upwards from the rail mount clamp. A lower leg cradle support base is affixed to the top of the arm and a lower leg cradle body pivots on the lower leg cradle support base, allowing for rotational adjustment and fixation along the direction of the operating table rail. This device allows a number of adjustments to be made to the position of patient's leg, but its design is not such as to make it useful in anterior approach total hip replacement surgery. The device of Aboujaoude always immobilises the leg in a position of hip flexion, above the surface of the operating table, whereas the anterior approach requires the hip to be neutral or extended.

A similar accessory is described in U.S. Pat. No. 7,316,040 (“Siccardi”). The accessory of Siccardi bolts directly to a fixed point on an operating table and includes a joint that is said to provide three degrees of freedom of movement, but only seems to provide two. A track extends from that joint, to which limb support components are attached, and there appears to be a support leg with a wheel at the bottom and a telescopic strut attached to the leg, although the purpose of these components is unclear.

A more sophisticated table-mounted accessory is described in international patent publication no. WO2007/080454 (“Smith & Nephew”), this accessory being designed to bolt up to and be supported by a lateral rail of an operating table and to provide distraction of the hip at both supine and lateral positions of the patient on the table. One of the problems with accessories such as this is that they are cumbersome and time-consuming to set up on the operating table. They are very heavy and often require several technicians to assemble them in position. They transfer all of their own weight and that of the patient's limb through the lateral rail of the operating table.

The operating table accessory described in international patent publication no. 2006/051077 (“Memminger”) is one attempt to deal with the problems identified above and consists of a floor standing section that can be wheeled up to and attached to a patient trolley to provide support and distraction to the patient's leg. Another such accessory, albeit more complex, is described in U.S. Pat. No. 4,527,555 (“Ruf”).

However, one thing that is always to be borne in mind when undertaking surgical procedures of the kind described, is that things do not always go according to plan. Virtually all modern operating tables have an emergency tilt position into which they can be put if the patient suffers a cardiac arrest or other life-threatening emergency. The emergency tilt position is one in which the table tilts so that the patient lies at an angle of 10° to 15° with his head lower than his feet, and the surgeon needs to be able to put him into this position at a moment's notice. Neither Memminger nor Ruf allows this.

### SUMMARY

One of the inventions that has been conceived allows the use of an operating table accessory that is easy for a single person to set up relative to the operating table, yet still permits the table to adopt its emergency tilt position.

To that end, there is provided an operating table accessory for use during surgery on a limb, comprising a component to be mounted on an operating table and including a patient support, a floor-standing component including an articulated limb support, and cooperating locating features on the two components, adapted to locate the components relative to each other such that with the patient support supporting at least some of the weight of the patient, the articulated limb support is properly positioned to support and manipulate the limb, the cooperating locating features being so configured as to allow the table to be tilted relative to the floor-standing component while continuing to locate the components relative to each other.

Because the floor-standing component is floor-standing, it is coupled to the table by the locating features, but is not cantilevered from it, or in other words it does not require the table to bear its weight. It is a self-supporting component. This means there will be no need for the technicians to lift it into place before it can be coupled to the operating table. This makes it particularly easy to set up, but the invention improves upon previously-proposed floor-standing accessories by the use of cooperating locating features that accommodate tilting of the table relative to the floor-standing component.

One way of implementing such cooperating locating features is for one component to comprises a first part having a notch as a locating feature and the other component to comprise a second part having a pair of outwardly facing guide channels on either side as a locating feature, each guide channel having an outwardly facing base surface, the notch and the guide channels being adapted to locate the two components relative to each other by receipt of the second part into the notch and by receipt of the margins of the first part adjacent to the sides of the notch into respective guide channels. In this case, the guide channels and the margins of the first part adjacent to the sides of the notch should be so shaped as to allow the two parts to tilt relative to one another, thus allowing the table to be tilted relative to the floor-standing component while continuing to locate the components relative to each other. The first part can be a part of the table-mounted component and the second part, a part of the floor-standing component.

Because the accessory of this invention was originally conceived for use in surgery that involves limb distraction, although it should be clear that it can be used in other procedures too, the floor-standing component may comprise a substantially vertical reaction post and a thrust element that can be mounted on the reaction post. The reaction post provides a reference against which the distraction forces can be applied and the thrust element provides the surface against which the reaction forces from another part of the patient's body will be exerted. As an alternative, the thrust element may comprise the substantially vertical reaction post, which can then be mounted on the floor-standing component. For example, in the case of the anterior approach to total hip replacement, the thrust element will receive the reaction forces from the perineum as the distraction forces are applied to the lower leg. In the case of a shoulder arthroscopy where it is convenient to distract the glenohumeral joint, the distraction forces may be applied at the wrist and the thrust element will receive the reaction forces from the armpit. In one implementation, the thrust element is a thrust spacer having a vertical bore for sliding receipt of the reaction post and a thrust surface horizontally spaced from the vertical bore. In the alternative mentioned above, the bore may be in the floor-standing component, for sliding receipt of the reaction post affixed to the thrust element.

The use of a reaction post in the floor-standing component enables the second of the inventions presented here, which is independent of the first. Virtually every piece of equipment in an operating theatre is movable, because the theatre needs to be reconfigured as required, but what this can mean is that the surgeon's instruments, even if placed in an instrument tray, will ultimately be placed on a movable piece of equipment, such as a trolley, and may be moved. As anyone who has even so much as misplaced a screwdriver in his workshop will know, this can be extremely frustrating, and that is a state of mind that it would be better for a surgeon to avoid. However, once the accessory previously discussed has been arranged and located relative to the operating table, the reaction post provides what may be the only stationary point in the whole operating theatre. This invention takes advantage of that.

Thus, to provide a secure and fixed location for the surgeon's instruments, there is provided an operating table accessory for use during surgery on a limb, comprising a component to be mounted on an operating table and including a patient support, a floor-standing component including a substantially vertical reaction post, and an articulated limb support, cooperating locating features on the two components, adapted to locate the components relative to each other such that with the patient support supporting at least some of the weight of the patient, the articulated limb support is properly positioned to support and manipulate the limb, an instrument tray, and means for reversibly attaching the instrument tray to the reaction post.

Where a reaction post and thrust element are present, the thrust element can be used to provide the locating feature of the floor-standing component. In particular, the accessory may be designed so that the patient support has a notch as a locating feature, the thrust element has a pair of outwardly facing guide channels on either side as a locating feature, each guide channel having an outwardly facing base surface, the notch and the guide channels being adapted to locate the two components relative to each other by receipt of the thrust element into the notch and by receipt of the margins of the patient support adjacent to the sides of the notch into respective guide channels. In this case, the guide channels and the margins of the patient support adjacent to the sides of the notch should be so shaped as to allow the patient support and the thrust element to tilt relative to one another, thus allowing the table to be tilted relative to the floor-standing component while continuing to locate the components relative to each other.

The use of a thrust element that slides up and down the reaction post allows the table to be raised and lowered relative to the floor-standing component while the locating features continue to locate the components relative to each other. It also means that a greater degree of tilt of the table, or a tilt about an axis that is a greater distance from the locating features can be accommodated.

For reasons of convenience as well as visualisation, the thrust element may be a thrust spacer having upper and lower sections and a vertical bore for sliding receipt of the reaction post, the upper section having a thrust surface horizontally spaced from the vertical bore and the lower section having the guide channels on either side.

Given that the patient support and the thrust element are both going to be in the vicinity of the joint of interest, especially in the case of total hip replacement or shoulder arthroscopy, the patient support and the thrust element may be radiolucent. This facilitates X-ray imaging of the operative joint and is especially useful in the case where the thrust surface of the thrust element is spaced from the vertical reaction post, which itself is likely to be made from metal or other radiopaque material.

This allows the introduction of the third of the inventions presented here, which is concerned with facilitating the X-ray imaging of an operative joint during surgery, and is independent of the ability to accommodate tilting of the operating table or ability to put an instrument tray in a fixed position. To that end, there is provided an operating table accessory for use during surgery on a limb, comprising a component to be mounted on an operating table and including a patient support, a floor-standing component including a substantially vertical reaction post, a thrust spacer having a thrust surface, the thrust spacer being adapted to be mounted on the reaction post so that the thrust surface is horizontally spaced from the reaction post, and an articulated limb support, and cooperating locating features on the patient support and the thrust spacer, adapted to locate the components relative to each other such that with the patient support supporting at least some of the weight of the patient, the articulated limb support is properly positioned to support and manipulate the limb, wherein the patient support and the thrust spacer are radiolucent.

For the purposes of improved operative visualisation, the accessory may further comprise an X-ray grid for attachment to the patient support, or the patient support may incorporate an X-ray grid.

In the case where the locating features include guide channels and margins adjacent to the sides of a notch, so shaped as to allow the two parts to tilt relative to one another, the said margins may be substantially flat and the guide channels, crowned. The guide channels may be crowned on both their upper and lower surfaces.

To assist with proper alignment of the component parts, the sides of the notch and the base surfaces of the guide channels can cooperate to constrain relative rotation between the first part or patient support and the second part or thrust element, as the case may be, about a vertical axis. One way of achieving this is for the sides of the notch and the base surfaces of the guide channels to be substantially straight, and the angle between the sides of the notch to be substantially equal to the angle between the base surfaces of the guide channels. The sides of the notch may be substantially parallel and the base surfaces of the guide channels may be substantially parallel too, although it may be better for there to be an included angle to assist in initial location of the components.

For additional security, the operating table accessory may further comprise means for reversibly retaining the two components in a position such that with the patient support supporting at least some of the weight of the patient, the articulated limb support is properly positioned to support and manipulate the limb.

To allow the patient's limb to be manipulated during surgery, the limb support may be adapted to swivel substantially horizontally relative to the floor-standing component, for example by being mounted on and adapted to swivel with respect to the reaction post. To secure the limb in position, means may be provided for reversibly locking the limb support to prevent it from swivelling.

Vertical articulation of the limb can be accommodated by a proximal articulation of the limb support. So that the surgeon or other personnel need not bear the whole weight of the limb, the limb support may be biased upwards, for example by means of a gas strut. To prevent the limb from being dropped accidentally while attached to the limb support, the proximal articulation may comprise a releasable ratchet mechanism that permits the limb support to be raised, but not lowered until the ratchet mechanism is released. The limb support may comprise a distal release actuator operable to release the ratchet mechanism.

A bilateral version of the operating table accessory can be provided by furnishing the floor-standing component with a second articulated limb support. The first and second articulated limb supports may be laterally displaced from one another by being mounted, for example, to either side of the reaction post.

So as to provide at least gross adjustments to the length of the limb that the limb support can accommodate, the floor-standing component may further comprise a carriage movable with respect to the limb support along a predetermined path and adapted to engage a receptacle that holds the limb, and an interlock device adapted to lock the carriage to the limb support in any one of a number of positions distributed along the predetermined path, thus to prevent movement of the carriage along the path.

The interlock device may include a movable component and a stationary component, one on the carriage and the other on the limb support, the movable component being movable between an active position in which it engages the stationary component and an inactive position in which it does not, and the stationary component including a plurality of recesses adapted to receive the movable component when in its active position.

It is typical in equipment of this sort for the parts to be manufactured to extremely high tolerances. Witness, for example, the abstract of Aboujaoude, “ . . . a device or fixture for positioning and manipulating a patient's lower extremity for surgical and diagnostic procedures where alignment is critical and minute adjustments may be required.” However, what is little suspected or little known, is that these critical and minute adjustments are rarely needed. In a total hip replacement, for example, so long as the postoperative leg is different in length from the preoperative leg by no more than about 10 mm (more in some cases), the patient simply will not notice the difference. Thus, lower precision parts can be used and the carriage can be mounted on the limb support with a degree of play such that a limited range of movement of the carriage relative to the limb support is possible without moving the carriage along the predetermined path. The interlock device should then be so constructed as to accommodate the said degree of play, and be capable of locking the carriage to the limb support throughout the said limited range of movement.

A fourth of the inventions presented here takes advantage of the fact that critical tolerances are rarely required in equipment such as that described in this application. Again, it is independent of the inventions previously presented. To that end, there is provided an operating table accessory for use during surgery on a limb, comprising a limb support, a carriage movable with respect to the limb support along a predetermined path and adapted to engage a receptacle that holds the limb, and an interlock device adapted to lock the carriage to the limb support in any one of a number of positions distributed along the predetermined path, thus to prevent movement of the carriage along the path, wherein the carriage is mounted on the limb support with a degree of play such that a limited range of movement of the carriage relative to the limb support is possible without moving the carriage along the predetermined path, and wherein the interlock device is so constructed as to accommodate the said degree of play, and is capable of locking the carriage to the limb support throughout the said limited range of movement.

A fifth of the inventions presented here is concerned with the retention of the limb receptacle on the limb support. Again, it is independent of the inventions previously presented. Conventional mechanisms are not very convenient to use and typically require the limb receptacle to be mounted before the limb is attached, or involve an attachment mechanism that is difficult to use once the limb has been attached. To this end, there is provided an operating table accessory for use during surgery on a limb, comprising a limb support, a receptacle adapted to hold the limb, and cooperating retention features on the limb member and the limb receptacle, one of the retention features comprising a channel with an open end for receipt of the other retention feature and a closed end including means for reversibly retaining the other retention feature, wherein the size of the channel increases from the closed end to the open end, so as to facilitate receipt of the other retention feature into the open end of the channel, whereupon the other retention feature can be conveyed and guided along channel to the closed end to be retained in position at the closed end by the reversible retaining means.

The retention feature with the channel may be provided on the limb receptacle since in that way the other retention feature can be guided into closer proximity with the limb receptacle. Thus, there is provided a limb receptacle adapted to hold a limb and comprising a retention channel with an open end for receipt of a retention feature of a limb support and a closed end including means for reversibly retaining the retention feature, wherein the size of the channel increases from the closed end to the open end, so as to facilitate receipt of the other retention feature into the open end of the channel, whereupon the other retention feature can be conveyed and guided along the channel to the closed end to be latched into position at the closed end by the reversible retaining means.

The retention feature on the limb support may be a retention feature on a carriage that is movable with respect to the limb support along a predetermined path, including a carriage mounted on the limb support with a degree of play as previously mentioned.

The limited range of movement of the carriage relative to the limb support allowed by the degree of play may include limited rocking of the carriage transversely to the predetermined path. As stated above, the interlock device may include a movable component and a stationary component, one on the carriage and the other on the limb support, the movable component being movable between an active position in which it engages the stationary component and an inactive position in which it does not, and the stationary component including a plurality of recesses adapted to receive the movable component when in its active position. In this case, the size of the recesses measured in the direction of the predetermined path should exceed the corresponding size of the movable component by an amount that is less than the amount by which the size of the recesses measured in the direction transverse to the predetermined path exceeds the corresponding size of the movable component.

The predetermined path may be defined by a track on the limb support, the carriage including a chassis that movably engages the track. The limited rocking of the carriage is most discernable in the case where the carriage is reconfigurable between a first configuration in which its centre of mass lies to one side of the contact between the follower and the track and a second configuration in which its centre of mass lies to the other side. This may be the case where the accessory is reconfigurable from a left-handed to a right-handed configuration to allow an operation to proceed on the left or the right hip, as the case may be. The carriage may be reconfigurable by virtue of its further including a superstructure adapted to engage the limb receptacle and mounted on the chassis for movement between first and second positions corresponding to the first and second configurations of the carriage respectively.

To allow finer adjustments to the limb length, or to provide for distraction of the limb, the carriage may include both a retention feature adapted to engage a corresponding retention feature on the limb receptacle and means for advancing and retracting the retention feature relative to the carriage in a direction substantially aligned with the predetermined path.

As is typical, the means for advancing and retracting the retention feature may include a lead screw actuator. The lead screw may be driven by a hand wheel, and the retention feature connected to the lead screw nut.

In addition, to provide internal or external rotation of the limb, the retention feature on the limb carriage may be rotatable relative to the limb support, thus allowing the limb receptacle to rotate relative to the carriage. Locking means may be provided for preventing the rotation of the retention feature.

Although, as previously explained, exact tolerances are rarely required in equipment such as this, it is nevertheless useful for a surgeon to have some idea of the relative positions of the operative limb and the rest of the patient's body, since this will help him to ensure that the postoperative limb is about as long as it was preoperatively. The sixth of the inventions presented here is directed to that end and provides an operating table accessory for use during surgery on a limb, comprising a limb support, a carriage movable with respect to the limb support along a predetermined path and adapted to engage a receptacle that holds the limb, a scale along or adjacent to the predetermined path on the limb support, and a display device on the carriage adapted to read the scale and display information indicative of the position of the carriage along the predetermined path. Again, the sixth invention is independent of the inventions previously presented.

The scale may comprise a series of equally spaced detectable markers and the display device comprises means for counting the number of markers past which it has moved and to display information indicative of that number. For example, the detectable markers may be optically or magnetically detectable, and the display device comprise an optical or magnetic detector. To allow the surgeon to “zero” the display preoperatively, the information indicative of the position of the carriage along the predetermined path can be reset at any position of the carriage, for example by resetting the count maintained by the counting means. To this end, the display device may include a reset button for resetting the information or count.

It is useful in anterior approach total hip replacement to provide some means for elevating the proximal end of the cut femur, to facilitate the broaching and installation of the femoral neck. Similar means for elevating the limb are equally useful in other procedures. Thus, the floor-standing component may further include a proximal limb pad, wherein the cooperating locating features on the two components are adapted to locate the components relative to each other such that the proximal limb pad lies below a proximal portion of the limb, and means for reversibly raising the limb pad relative to the limb receptacle to apply a lifting force to the proximal portion of the limb.

The seventh of the inventions presented here relates to the provision of a proximal limb pad. Again, it is independent of the inventions previously presented. To that end, there is provided an operating table accessory for use during surgery on a limb, comprising a component to be mounted on an operating table and including a patient support, a floor-standing component including an articulated limb support, a receptacle adapted to hold the limb, and cooperating retention features on the limb support and the limb receptacle, a proximal limb pad on one of the two components, cooperating locating features on the two components, adapted to locate the components relative to each other such that with the patient support supporting at least some of the weight of the patient and the limb receptacle holding the limb, the articulated limb support is properly positioned to support and manipulate the limb and the proximal limb pad lies below a proximal portion of the limb, and means for reversibly raising the limb pad relative to the limb receptacle to apply a lifting force to the proximal portion of the limb.

The means for reversibly raising the limb pad relative to the limb receptacle may comprise means for fixing the limb pad in a plurality of vertical positions relative to the limb support, which would require manual adjustment, or it may comprise a motor. Alternatively, the raising of the limb pad relative to the limb receptacle may be achieved by moving the receptacle rather than the pad, for example by means of a proximal articulation of the limb support that allows the limb support to be raised and lowered. Here, the proximal limb pad may be on the floor-standing component.

As an alternative, the limb pad may be mounted for rotation about an eccentric pivot and the means for reversibly raising the limb pad relative to the limb receptacle comprise means for reversible rotating the limb pad about its eccentric pivot. This may be achieved by means for fixing the limb pad in a plurality of angular positions about its eccentric pivot. Here, the proximal limb pad may be on the table-mounted component. The proximal limb pad may be mounted onto the table-mounted component in such a way that the position of the eccentric pivot relative to the table-mounted component is adjustable.

Whilst the inventions presented here have in many cases been discussed with reference to a first component that is adapted to be mounted on an operating table, it will be understood that that component may be an integral feature of the table itself. Thus, alternative statements of the first, second, third and seventh inventions are as follows.

In respect of the first invention, there is also provided operating room equipment for use during surgery on a limb, comprising an operating table, a floor-standing accessory including an articulated limb support, and cooperating locating features on the table and the accessory, adapted to locate them relative to each other such that with the operating table supporting the weight of the patient, the articulated limb support is properly positioned to support and manipulate the limb, the cooperating locating features being so configured as to allow the table to be tilted relative to the accessory while continuing to locate the table and the accessory relative to each other.

In respect of the second invention, there is also provided operating room equipment for use during surgery on a limb, comprising an operating table, a floor-standing accessory including a substantially vertical reaction post and an articulated limb support, cooperating locating features on the table and the floor-standing accessory, adapted to locate them relative to each other such that with the table supporting the weight of the patient, the articulated limb support is properly positioned to support and manipulate the limb, an instrument tray, and means for reversibly attaching the instrument tray to the reaction post.

In respect of the third invention, there is also provided operating room equipment for use during surgery on a limb, comprising an operating table including a locating extension, a floor-standing accessory including a substantially vertical reaction post, a thrust spacer having a thrust surface, the thrust spacer being adapted to be mounted on the reaction post so that the thrust surface is horizontally spaced from the reaction post, and an articulated limb support, and cooperating locating features on the locating extension and the thrust spacer, adapted to locate the table and the floor-standing accessory relative to each other such that with the table supporting the weight of the patient, the articulated limb support is properly positioned to support and manipulate the limb, wherein the locating extension and the thrust spacer are radiolucent.

In respect of the seventh invention, there is also provided operating room equipment for use during surgery on a limb, comprising an operating table, a floor-standing component including an articulated limb support, a receptacle adapted to hold the limb, cooperating retention features on the limb support and the limb receptacle, and a proximal limb pad, cooperating locating features on the table and the floor-standing accessory, adapted to locate them relative to each other such that with the table supporting the weight of the patient and the limb receptacle holding the limb, the articulated limb support is properly positioned to support and manipulate the limb and the proximal limb pad lies below a proximal portion of the limb, and means for reversibly raising the limb pad relative to the limb receptacle to apply a lifting force to the proximal portion of the limb.

This invention also encompasses an operating table accessory to be mounted on an operating table for use during surgery on a limb, comprising a patient support adapted to support at least some of the weight of the patient, and a proximal limb pad mounted on the accessory for rotation about an eccentric pivot, such that rotation of the limb pad about the eccentric pivot reversibly raises the limb pad to apply a lifting force to a proximal portion of a limb.

An accessory component including a patient support may be mounted on the table and the locating feature on the table may then be a locating feature of the table-mounted accessory component. For example, the accessory component may be mounted on the table so as to be extendable from it and the locating features, so configured as to allow them to be approximated and to locate the components relative to each other such that with the patient support supporting at least some of the weight of the patient, the articulated limb support is properly positioned to support and manipulate the limb, by extension of the accessory component from the table.

Returning to the first of the inventions presented here, an improved method of preparing an operating table for surgery can be implemented. The method includes positioning a floor-standing accessory including an articulated limb support adjacent to the operating table, and offering a locating feature on the table up to a cooperating locating feature on the floor-standing accessory, to locate them relative to each other such that with the table supporting the weight of the patient, the articulated limb support is properly positioned to support and manipulate the limb, the cooperating locating features being so configured as to allow the table to be tilted relative to the floor-standing component while continuing to locate the components relative to each other.

The method may further comprise mounting an accessory component including a patient support on the table, in which the locating feature on the table is a locating feature of the table-mounted accessory component. Mounting the accessory component on the table may involve offering the locating feature of the table-mounted accessory component up to the cooperating locating feature on the floor-standing accessory.

As an alternative to this, the table may have mounted on it an extendable accessory component including a patient support, and the locating feature on the table is then offered up to the cooperating locating feature on the floor-standing accessory by extending the extendable accessory component. As previously discussed, the extendable accessory component may have a notch as a locating feature and the floor-standing accessory may comprise a locating part having a pair of outwardly facing guide channels on either side as a locating feature, each guide channel having an outwardly facing base surface. The guide channels and the margins of the patient support adjacent to the sides of the notch are so shaped as to allow the patient support and the thrust element to tilt relative to one another, thus allowing the table to be tilted relative to the floor-standing component while continuing to locate the components relative to each other. Thus, the notch and the guide channels are offered up to one another by receiving the locating part into the notch and by receiving the margins of the extendable accessory component adjacent to the sides of the notch into respective guide channels. In one implementation, the floor-standing component comprises a substantially vertical reaction post, and a thrust element that can be mounted on the reaction post, and the thrust element is the locating part.

### THE DRAWINGS

The inventions presented here will be described with reference to the accompanying drawings, in which:

FIG. 1 is an isometric view of an operating table accessory for use in anterior approach total hip replacement;

FIG. 2 is a side elevation of the operating table accessory of FIG. 1;

FIG. 3 shows the attachment of a side frame member to an operating table;

FIG. 4a shows the mounting of a patient support plate on the side frame members;

FIGS. 4b and 4c show details from FIG. 4a;

FIGS. 5a and 5b show how the patient support plate is clamped in place;

FIG. 6 shows three views of the patient support plate, together with certain lines of construction and dimensions;

FIG. 7 shows multiple views of the thrust spacer, together with certain lines of construction and dimensions;

FIGS. 8 and 9 illustrate reversible retaining mechanisms for the patient support plate and the thrust spacer;

FIG. 10 shows the attachment of the limb support to the reaction post;

FIG. 11 shows in detail a two-piece housing used to allow the limb support to swivel about the reaction post;

FIGS. 12a and 12b illustrate how the limb support is able to swivel about the reaction post;

FIG. 13 shows the proximal articulation of the limb support;

FIGS. 14 and 15 show the support articulation ratchet mechanism;

FIG. 16 illustrates the carriage and its component parts;

FIG. 17 illustrates the reconfiguration of the carriage;

FIG. 18 shows the attachment of a limb receptacle to the carriage;

FIG. 19 shows a position indicator;

FIG. 20 shows a femoral lift pad;

FIG. 21 shows a bilateral version of the accessory;

FIGS. 22-24 illustrate an improved folding side frame member;

FIGS. 25 and 26 illustrate a symmetrical patient support and an improved femoral lift pad;

FIGS. 27-30 illustrate an alternative reversible retaining mechanisms for the patient support plate and the thrust spacer to those shown in FIGS. 8 and 9;

FIGS. 31-34 illustrate a mechanism for retaining a folding side frame member like that of

FIGS. 22-24 in the deployed position; and

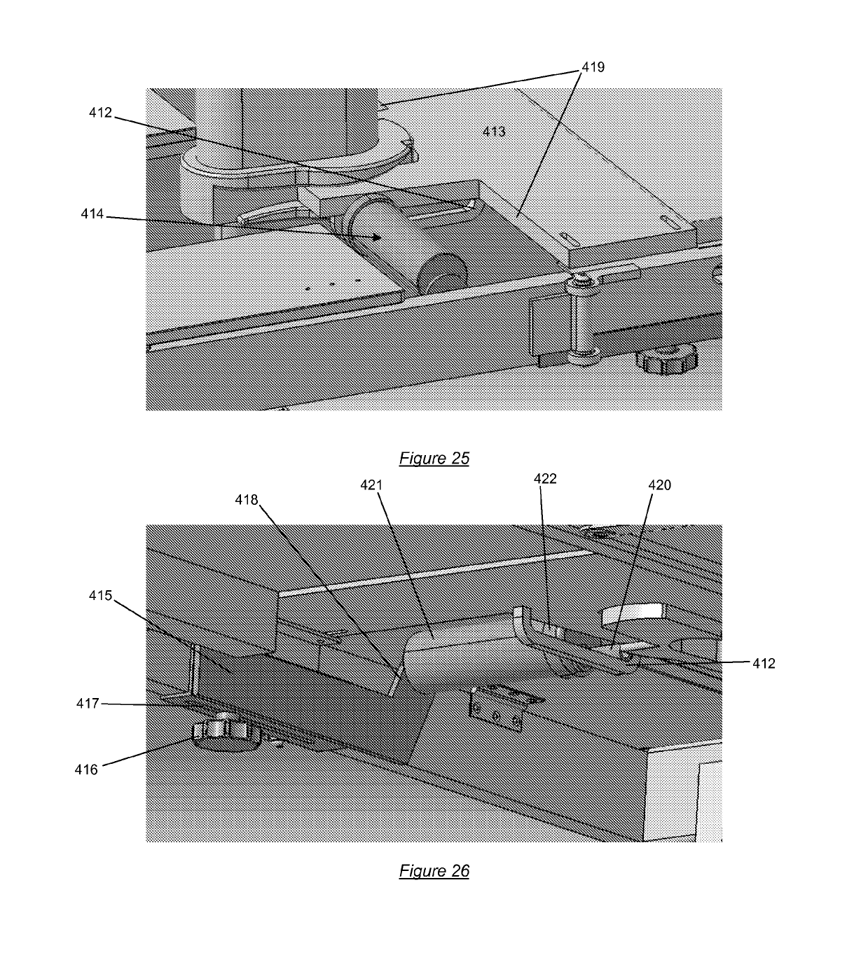

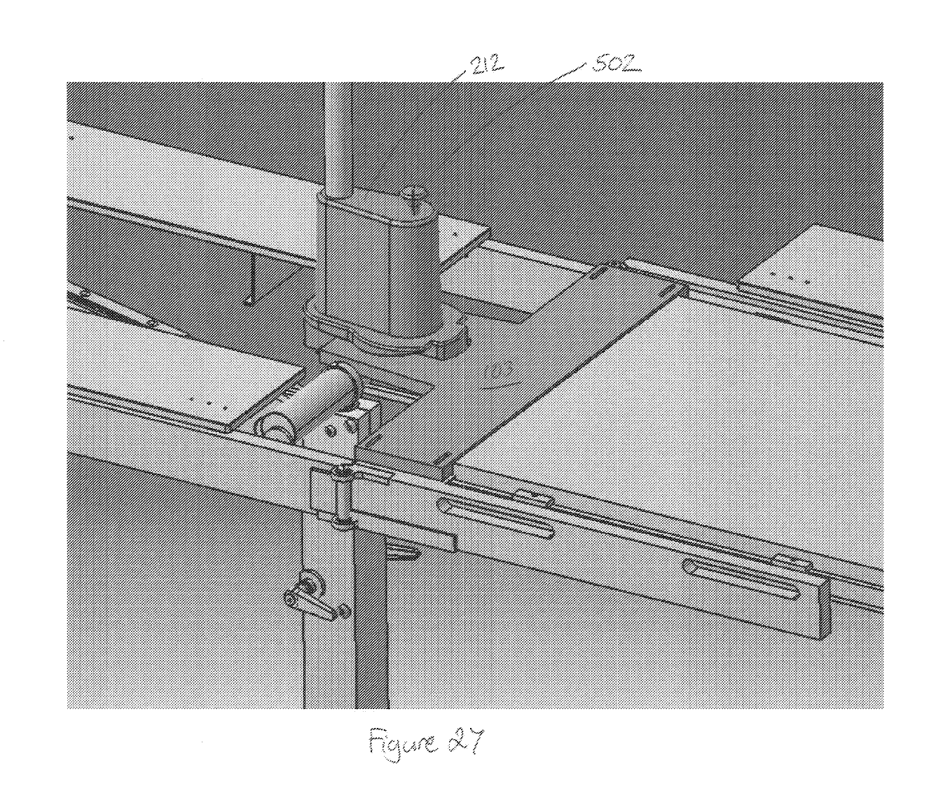

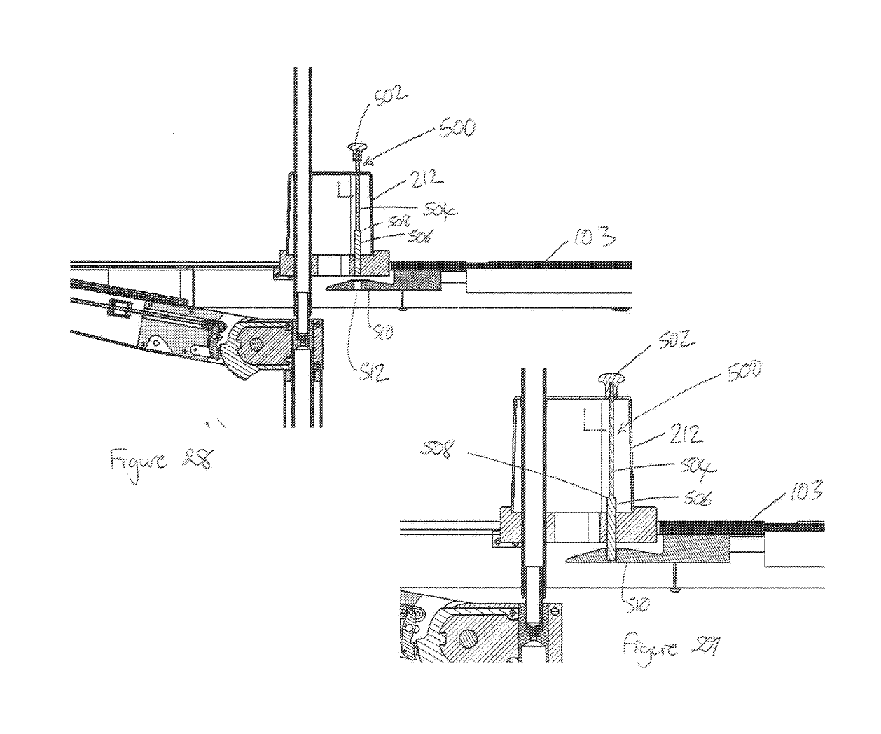

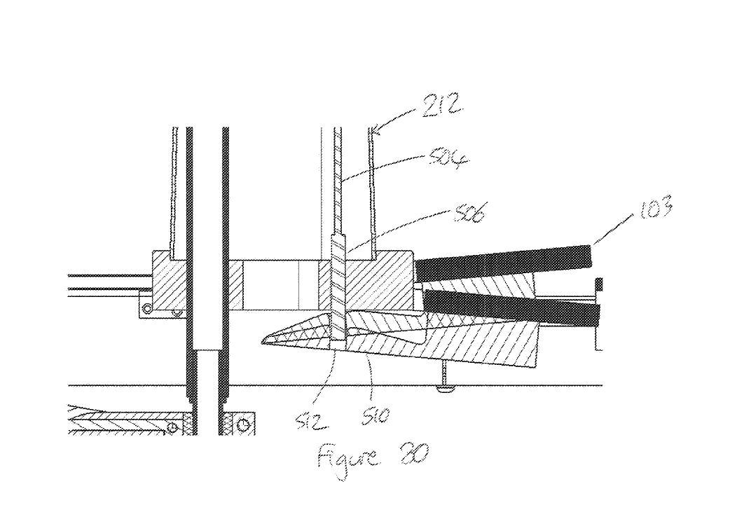

FIGS. 35 and 36 illustrate an alternative to the femoral lift pad of FIGS. 25 and 26.

### DETAILED DESCRIPTION

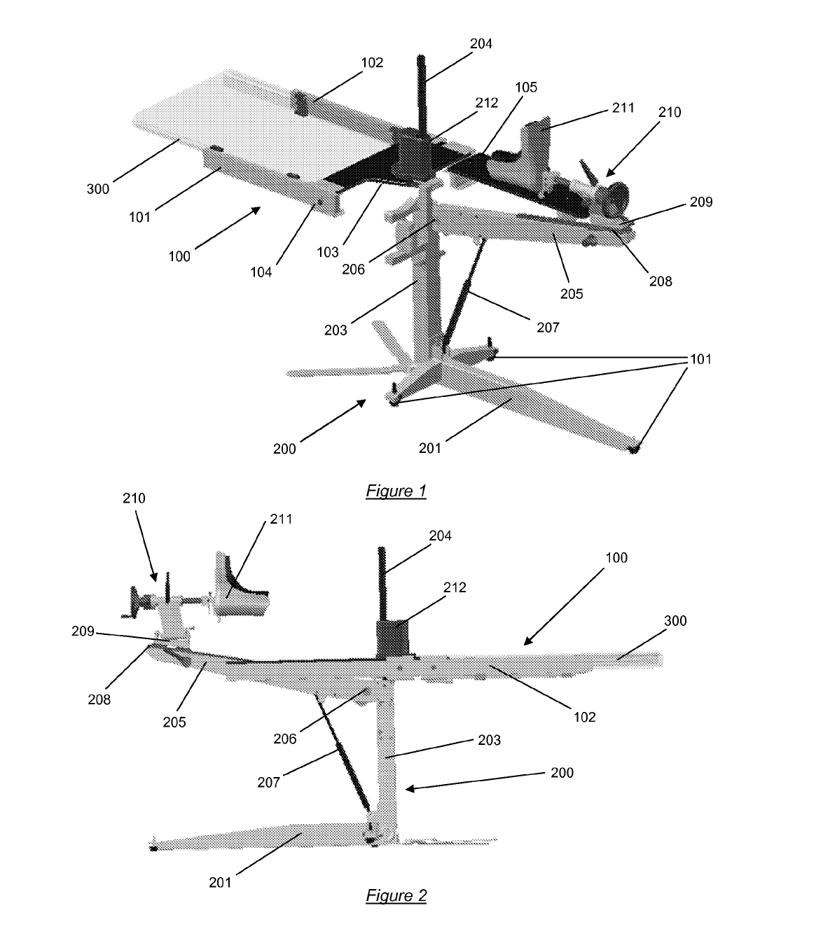

As illustrated in FIGS. 1 and 2, an operating table accessory for use in anterior approach total hip replacement includes a table-mounted component 100 and a floor-standing component 200.

The table-mounted component includes an aluminium left side frame member 101 and an aluminium right side frame member 102, each of which is designed to be affixed to a lateral accessory rail of an operating table 300. The left and right side frame members 101, 102 extend beyond the end of the operating table and are spanned by a radiolucent patient support plate 103. As will be described later, the patient support plate 103 is locked in place on each side frame member 101, 102 by an aluminium channel-section clamp plate 104. The right side frame member 102 is longer than the left side frame member 101 and on the end of the right side frame member is an additional, passive leg support plate 105 upon which the non-operative leg is supported during the operation.

The floor-standing component 200 includes an aluminium T-shaped base 201 with three height-adjustable feet 202, one at the end of the uptight of the T and the other two at respective ends of the cross-member. An aluminium box-section upright 203 extends vertically from the base 201 and a steel (or carbon fibre with a steel insert) vertical reaction post 204 extends out of the top of the box section upright 203. An aluminium support beam 205 is mounted on the reaction post 204 in such a way as to be able to swivel horizontally about the post 204. Vertical motion of the support beam 205 is permitted by means of a proximal articulation 206, which provides a horizontal axis about which the support beam 205 can be pivoted. The support beam is itself supported by a gas strut 207, linking a midpoint of the support beam 205 to the base 201. On top of the distal end of the support beam 205 is an aluminium track 208, along which a chassis 209 is able to slide. The chassis carries a superstructure including a lead screw mechanism 210, to the free end of which is attached a boot 211 that is adapted to retain the patient's foot. A perineal thrust spacer 212 is received on the reaction post 204 and is able to slide vertically with respect to it. With the exception of the reaction post 204, which will be made of steel, many of the remaining major components of the operating table accessory can be made of aluminium as already mentioned, or of a lighter weight carbon fibre composite material to aid in transportation.

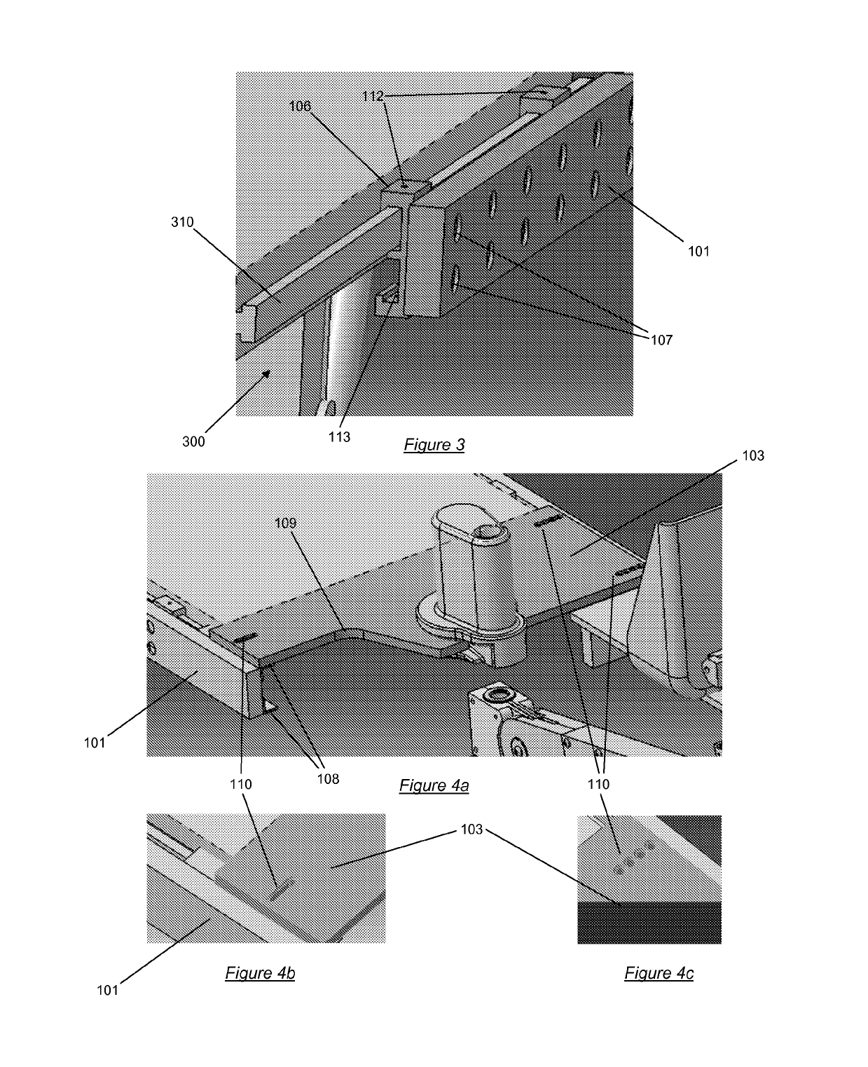

The attachment of the side frame members 101, 102 of the table-mounted component 100 to the operating table is illustrated in FIG. 3 in respect of the left side frame member 101. Attached to the left side frame member 101 is a plurality of E-shaped frame hangers 106, each of which is symmetrically shaped so as to be able to fit onto the side rail 310 of the operating table 300 both in the position shown in the figure and in an inverted position. This is to enable either side frame member 101, 102 to be assembled onto either side of the operating table without having to reverse the hangers, which in turn enables the same accessory to be conveniently used for left or right hip replacement. The frame member is for convenience illustrated as terminating just proximally of the proximal E-shaped hanger, but in practice it extends beyond it as illustrated in FIG. 4a.

Each of the frame members 101, 102 is a simple box section with multiple pairs of apertures 107 along an outermost face. A pair of bolts (not shown) has been inserted through the apertures 107, and through smaller holes in the innermost face of the side frame member to be screwed into corresponding threaded bores in the E-shaped frame hangers 106. Each of the multiple pairs of apertures 107 along the outermost face is lined up with a pair of smaller apertures in the innermost face, thus allowing the hangers 106 to be positioned in multiple positions. This is useful because not all operating table rails 310 are continuous as illustrated in the figure; the ability to move the hangers 106 means that discontinuities in the rail 310 can be accommodated.

Each of the E-shaped hangers 106 includes in upper threaded hole 112, and a corresponding lower threaded hole 113, the purpose of which is to permit the insertion of a fixing screw (not shown) that clamps down onto the lower surface of the rail 310, preventing the frame member from sliding relative to the rail. As shown, the hangers 106 are reversible and this facilitates the reconfiguration of the whole assembly when swapping from an operation of the right hip to an operation on the left hip.

As illustrated in FIG. 4a, the side frame member 101 includes at its distal end a pair of brackets 108, one upper and the other lower. The patient support plate 103 includes at the operative side of its distal end a cut-away 109 that facilitates manipulation of the operative limb. On this same side, the patient support plate 103 includes a transverse countersunk slot 110. A locating peg (not shown) can be dropped into the countersunk slot to pass through a locating aperture in the upper bracket 108. The head of the peg locates in the countersunk recess of the slot 110, and this locates the patient support plate 103 in the distal and proximal direction. The other, passive side of the patient support plate 103 includes two sets of transversely arrayed, countersunk bores 111. Additional locating pegs (also not shown) can be dropped into selected countersunk bores, to pass through locating apertures in upper bracket (similar to the brackets 108 shown). The heads of the pegs locate in the countersunk recess of the bores 111, and this locates the patient support plate 103 in the left and right direction, and also prevents it from being skewed relative to the side frame members 101, 102. The slot 110 and the bores 111 are countersunk on both faces of the patient support plate 103, because the patient support plate 103 is designed to be reversible. The provision of the slot 110 and bores 111 is to allow the plate to be mounted on tables of different width.

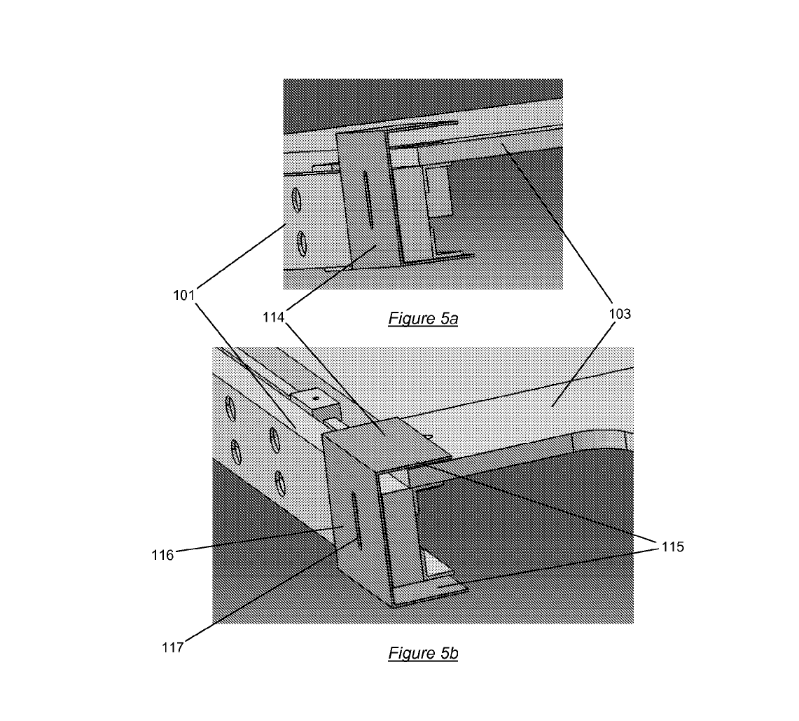

As shown in FIGS. 5a and 5b, the patient support plate 103 is clamped in place onto the side frame members 101, 102 by means for clamping plates 114. Each clamping plate is a short channel-section stainless steel clamp with upper and lower arms 115 and a midsection 116 joining the arms 115. The midsection has a slot 117 through which the shaft of a knurled screw (not shown) passes, to be retained by a captive bolt. Loosening the knurled screw allows the clamping plate 114 to be lifted from the locking position of FIG. 5b in which the locating pegs are obscured, to the released position in FIG. 5a, in which they are accessible, allowing the patient support plate to be relocated. Once the patient support plate 103 is positioned as desired, the clamping plates 114 are dropped down to the locking position of FIG. 5b, and the knurled screw is tightened down. The clamping plates 114 may be replaced by a thistle cloth fastening mechanism (Velcro for example), or by shaped pegs that are trapped in the holes with wire springs.

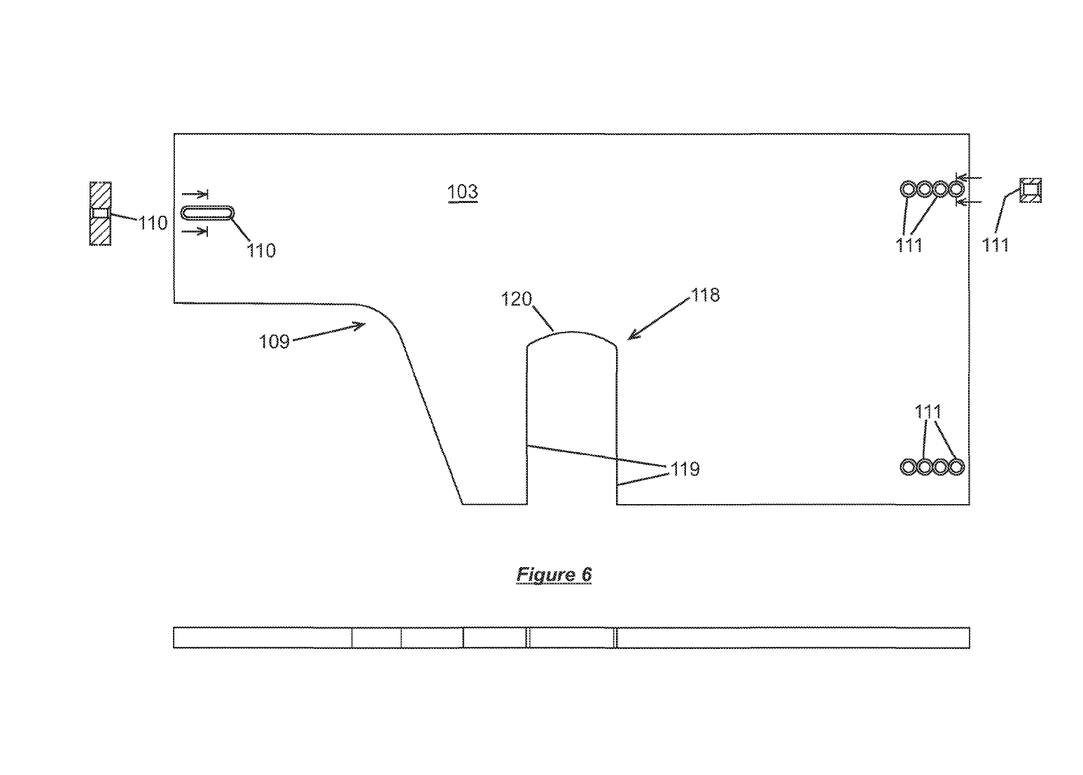

The shape of the patient support plate is best shown in FIG. 6, along with certain dimensions in millimetres. The plate is 15 mm thick throughout and includes, in addition to the slot 110, bores 110 and cut-out 109, a locating notch 118. The locating notch 118 has parallel sides 119 and a radiused end 120. The notch is 68 mm wide.

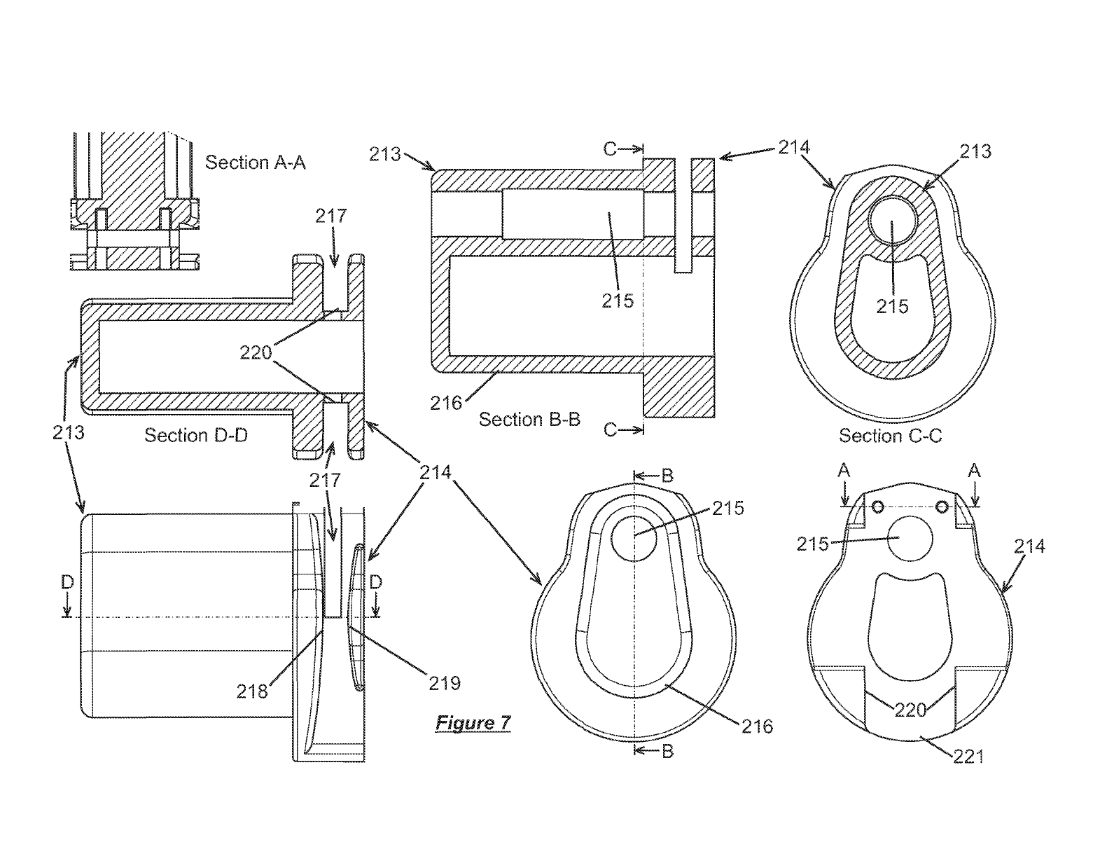

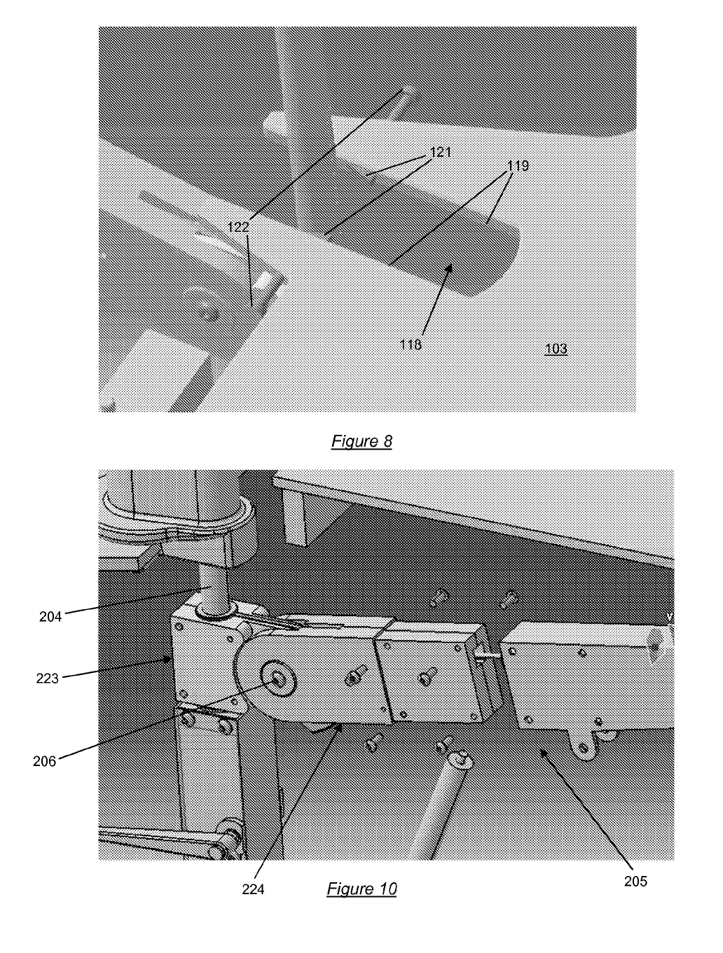

The structure of the thrust spacer 212 is illustrated in FIG. 7, again along with certain dimensions in millimetres. The thrust spacer 212 has an upper section 213 and a lower section 214 in the overall form of a flange and a vertical through-bore 215 for sliding receipt of the reaction post 204. The upper section 213 has a radiused thrust surface 216 horizontally spaced from the vertical bore 215. The lower flange section 214 is furnished on either side with a guide channel 217. Each guide channel 217 has crowned upper and lower surfaces 218, 219, and an outwardly facing base surface 220. At their closest, the upper and lower surfaces are 18 mm apart. The base surfaces are 66 mm apart and the distal end 221 of the lower section 213 is radiused to match the radiused end 120 of the notch 118 in the patient support plate 103.

The patient support plate 103 and the thrust spacer 212 are adapted to locate one another in the way illustrated in FIGS. 1 and 2. The lower part of the thrust spacer 212, between the guide channels 217, is received into the notch 118 in the patient support plate 103. At the same time, the margins of the patient support plate 103 that are adjacent to the parallel sides 119 of the notch 118 are received into the respective guide channels 217. The fact that the parallel sides 119 of the notch 118 are only 2 mm further apart than the base surfaces 220 of the guide channels 217 means that they cooperate to constrain relative rotation between the patient support plate 103 and the thrust spacer 212 about a vertical axis. This is what prevents the thrust spacer 212 from rotating about the reaction post 204. The same effect could be achieved by using an included angle (of, say, 5-10°) between the sides 119 of the notch 118 and the base surfaces 220 of the guide channels 217 and this may make them easier to locate.

The difference between the thickness of the patient support plate (15 mm) and the minimum distance between the crowned surfaces 218, 219 of the guide channels 217 (18 mm), together with the existence of the crowning on those surfaces, means that the patient support plate 103 and the thrust spacer 212 can remain engaged and located even when the patient support plate 103 has been tilted by an angle of 152 to 202. Because the thrust spacer 212 can slide upwards on the reaction post 204, the operating table can be tilted into its emergency tilt position about a transverse axis that is some distance from the engagement between the patient support plate 103 and the thrust spacer 212. The slide of the thrust spacer 212 on the reaction post 204 also allows the height of the operating table to be adjusted whilst the patient support plate 103 and the thrust spacer 212 remain engaged and located.

Both the patient support 103 and the thrust spacer 212 are constructed from a radiolucent material, such as reinforced polymer composites (e.g. glass fibre or carbon fibre composites), epoxy, polyether-ether-ketone (PEEK), thermoplastics, polyketones or polycarbonates, or any other radiolucent material with suitable mechanical properties, thus enabling X-ray imaging of the hip joint during surgery.

To help the surgeon to ascertain whether the pelvis has moved during the operation and otherwise to aid visualisation, an X-ray grid may be provided for attachment to the patient support, or the patient support may incorporate such a grid. The grid may be a simple mesh of radiopaque material, such as a metallic mesh, which can be fastened or screwed to the underside of the patient support plate 103, or insert-moulded or otherwise incorporated into the structure of the patient support plate 103.

Once the patient support plate and the thrust spacer have located one another, they can be retained in position by a reversible retaining mechanism. One such mechanism is illustrated in FIG. 8. Each side 119 of the notch 118 is furnished with a spring loaded pawl 121 that latches into a corresponding recess (not shown) in the base surface 220 of the corresponding guide groove 217 of the thrust spacer as the two are brought into engagement. The pawls 121 can be disengaged from the recesses by pulling the corresponding pin 122. Although two pawls 121 are illustrated, a reversible retaining mechanism could be implemented using only one pawl 121 and pin 122.

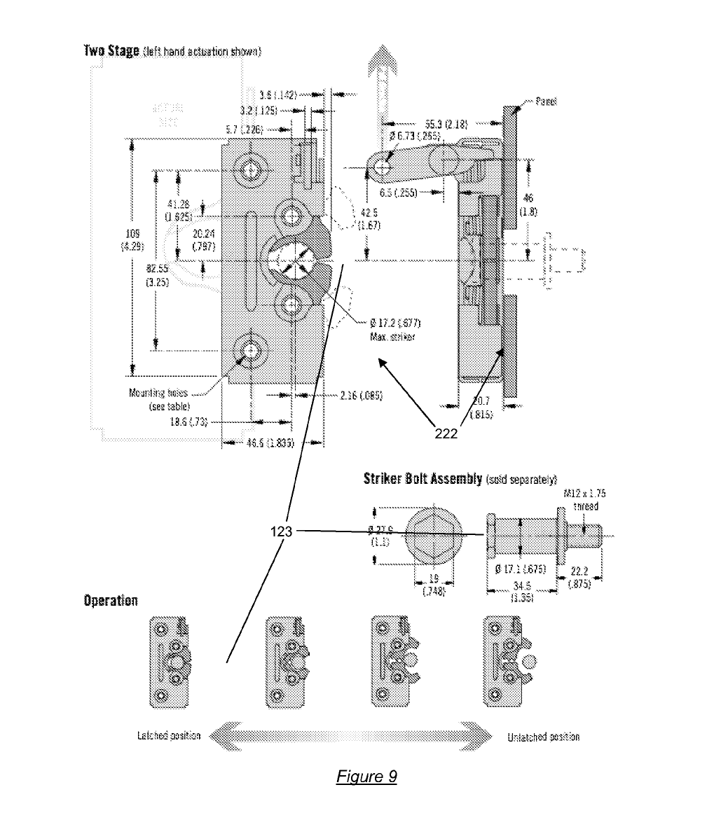

An alternative reversible retaining mechanism would use a two or three-stage dual-claw reversible latch and striker bolt, similar to those used in car doors, such as that shown in FIG. 9. The striker bolt 123 is fixed into the centre of the notch 118 in the patient support plate 103, so that the plate can be reversed for the left or right hip, and a push-to-close dual-claw latch 222 mounted in the corresponding position in the lower flange section 214 of the thrust spacer 212. The latch 222 may be releasable by a cable, a push-rod or a pull-rod.

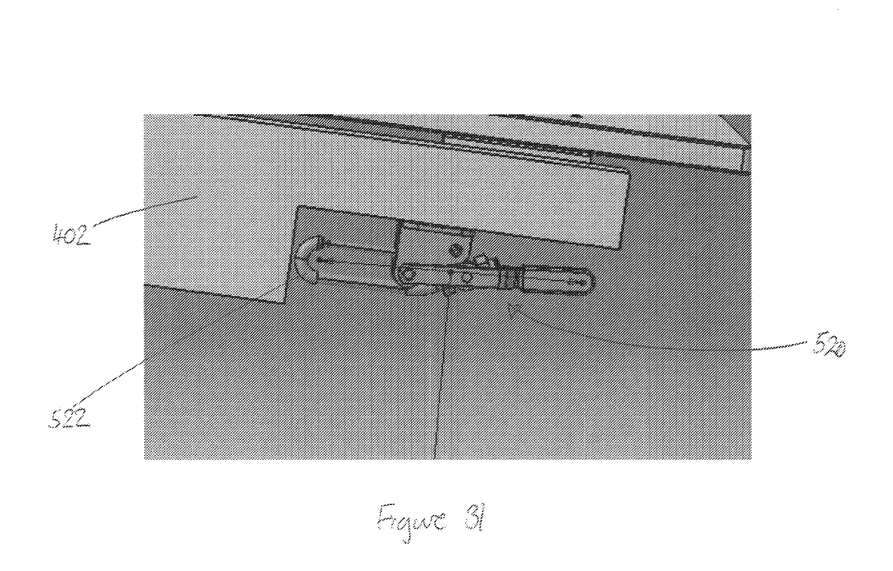

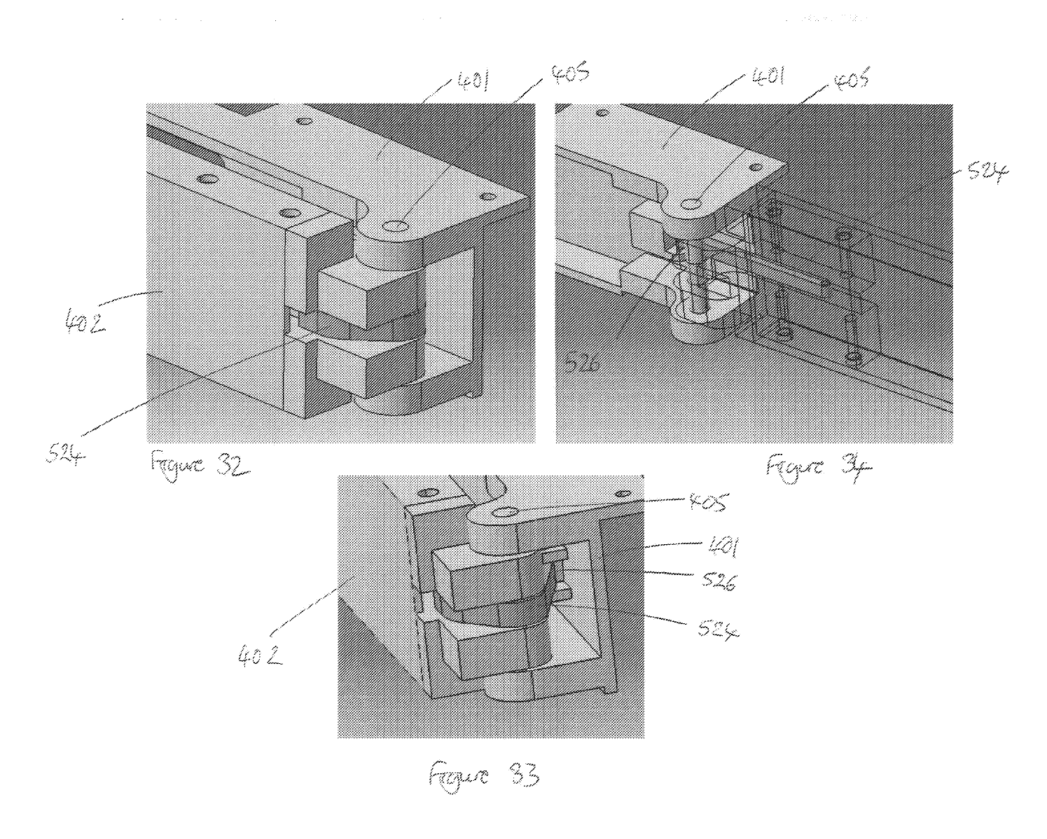

A further alternative reversible retaining mechanism is illustrated in FIGS. 27-30. Instead of the laterally-mounted spring-loaded pawl that is found in FIG. 8, in this case the thrust spacer 212 is furnished with a vertical latching rod 500 that passes through it from top to bottom. The latching rod 500 has a knob 502 at its upper end, this being fitted to the upper end of a relatively narrow upper section 504 of the latching rod 500. This upper section 504 of the latching rod 500 passes through a relatively small hole in the upper section of the thrust spacer 212. The lower section 506 of the latching rod 500 is relatively wide and passes through a relatively large hole in the lower section of the thrust spacer 212. By pulling the knob 502, the latching rod 500 can be raised from the lowered position shown in FIG. 29 to the elevated position shown in FIG. 28. If desired, some mechanism can be provided to prevent the latching rod 500 from being elevated beyond the position shown in FIG. 28, as further elevation may cause the lower section 506 to disengage from the relatively large hole in the lower section of the thrust spacer 212, making its return to the lowered position rather tricky. For example, a feature could be introduced into the interior of the thrust spacer 212 against which a shoulder 508 between the upper and lower sections 504, 506 of the latching rod 500 abuts in the elevated position. The latching rod may be spring-biased into the lowered position, or gravity may be left to do the trick.

The patient support plate 103 is in this case furnished with a distally projecting tongue 510, which slides beneath the thrust spacer 212 as the two parts are brought into engagement. This tongue 510 has a vertical latching bore 512 which, when the thrust spacer 212 and the patient support plate 103 are properly engaged, is in alignment with the latching rod 500, thus allowing the latching rod 500 to drop into the latching bore 512. As can be seen from FIG. 30, in the example shown, the latching bore 512 is flared, to accommodate tilting of the patient support plate 103 relative to the thrust spacer 212 (two extreme positions of the patient support plate 103 are shown in FIG. 30). An equally effective alternative would be to taper the lower end of the latching rod 500.

For reasons that have already been discussed, it may be advantageous to provide an instrument tray that can be reversibly attaching to the reaction post. This may be achieved using a tubular extension on the bottom of the instrument tray and a bayonet or similar fitting by means of which it can be affixed to the top of the reaction post 204.

FIG. 10 shows the attachment and articulation of the support beam 205 to the reaction post 204. The proximal end of the support beam 205 includes a two-piece swivel housing 223 affixed around the reaction post 204 and a two-piece articulation housing 224 affixed about the distal end of the swivel housing 223 at the proximal articulation 206. The two-piece swivel housing 223 is shown in FIG. 11 and includes a first piece 225 and a second piece 226, each of which includes a half-bore 227 with a locating groove 228 at about its mid-point. Fixing bolts 229 pass through holes 230 in the second piece 226 and screw into threaded holes 231 in the first piece 225. A bearing tube 233 is enclosed within the two half-bores 227 and a locating ring 232 of the bearing tube 233 is trapped within the locating grooves 228, restraining the bearing tube 233 against vertical movement. The swivel housing is clamped to the bearing tube 233 so that the two can rotate as one about the reaction post 204.

Sandwiched between the two pieces of the swivel housing 225, 226 is a ratchet gear 234 having upper and lower arms 235, each with a lug 236 through each of which one of the fixing bolts 229 passes. The gear 234 includes a toothed, part-circular outer surface 237 and in inwardly facing tab. A shape corresponding to that of the ratchet gear is let into each of the two pieces of the swivel housing 225, 226, so as to retain the gear securely in place.

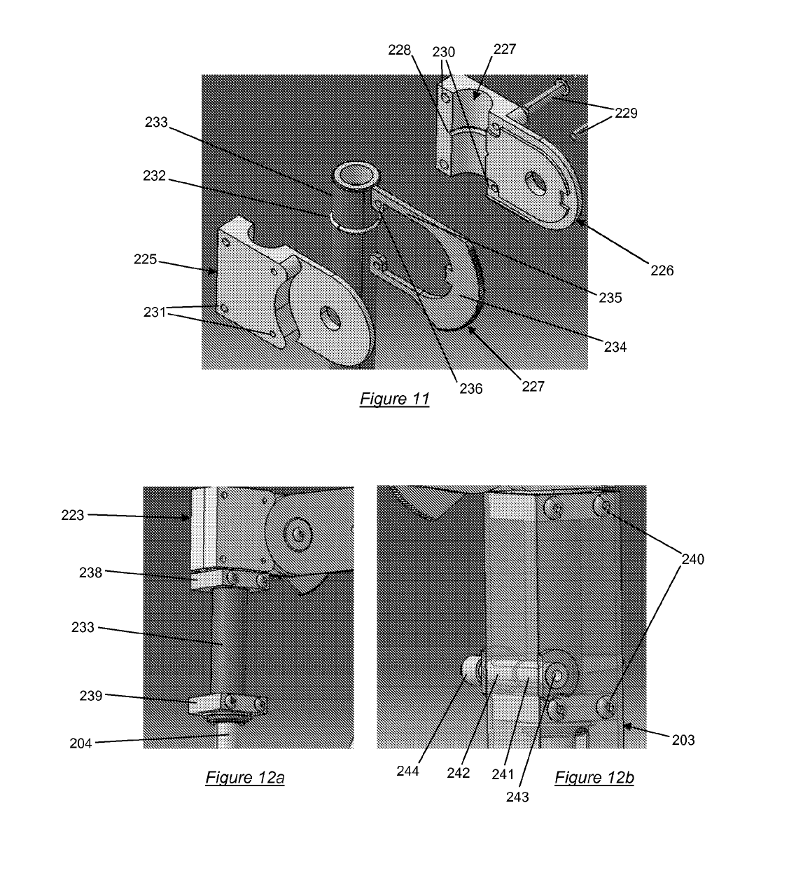

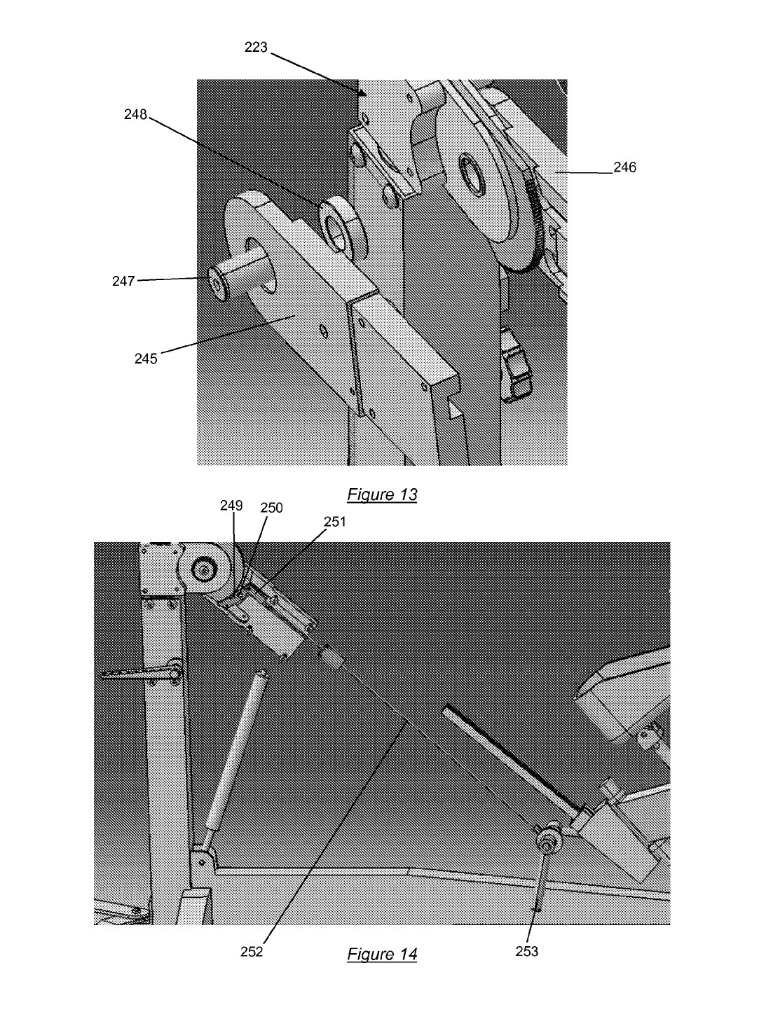

FIG. 12a shows upper and lower bearing blocks 238, 239 mounted on the bearing tube 233 and FIG. 12b shows the bearing blocks affixed to the inside of the box section upright 203 by means of fixings, namely Allen bolts 240, thereby mounting the bearing tube 233 and the swivel housing 223 for rotation about the reaction post 204. FIG. 12b also illustrates a mechanism for reversibly locking the bearing tube 233 relative to the box section upright 203. It consists of first and second tube clamping elements 241, 242 mounted on a common spindle 243 with a space between them. Each tube clamping element 241, 242 is ramped profiled at the point closest to the bearing tube 233 so that approximation of the tube clamping members will cause them to ride up onto and squeeze the surface of the bearing tube 233, thus locking it in place by friction. Approximation of the tube clamping members can be achieved in a number of ways. For example, as shown, the common spindle 243 is threaded at its distal end (closest to the viewer in FIG. 12b) and the first tube clamping member 241 is correspondingly threaded. The proximal end of the common spindle 243 is not threaded and so can rotate within the second tube clamping member 242. A handle 244 is provided affixed to the proximal and of the common spindle 243. Rotation of the handle 244 screws the common spindle 243 into the first tube clamping member 241, causing the handle 244 to bear against the second tube clamping member 242 to approximate the tube clamping members. As an alternative, instead of a handle 244, a quick-release cam lever of the type found on bicycle wheel spindles can be used. In such a case, the first tube clamping member 241 may be fixed to the distal end of the common spindle 243, although a threaded connection is preferred.

The two-piece articulation housing 224 is also illustrated in FIG. 13. It consists of a first piece 245 and a second piece 246 which are brought together with the distal portion of the swivel housing 223 between them. An articulation spindle 247 passes through the first piece 245 of the articulation housing, a thrust bearing 248, the distal portion of the swivel housing 223, a second thrust bearing (not shown) and the second piece 246 of the articulation housing. Finally a fixing bolt is passed through the articulation spindle and bolted up, for example with a locking nut on the other end, to secure the proximal articulation joint 206. A distal part of the support beam 205 bolts up to the two-piece articulation housing as illustrated in FIG. 10. Also in FIG. 10 can be seen the lugs on the support beam 205 to which the gas strut 207 attaches.

FIG. 14 shows a releasable ratchet pawl 249 within the articulation housing that engages the ratchet gear 234. For simplicity of illustration, the distal portion of the support beam 205 has been removed from FIG. 14. The ratchet pawl 249 is mounted to pivot about a boss 250 provided for that purpose at its centre. The toothed end of the ratchet pawl 249 engages the ratchet gear 234 and the other end is pivotally attached to a clevis 251 at one end of a push-rod 252 that extends along much of the length of the support beam 205. At the other end, the push-rod 252 attaches to a handle 253 positioned at the proximal end of the support beam 205. A spring (not shown) biases the pawl 249 into engagement with the gear 234.

Many of the same components are shown enlarged in FIG. 15, but FIG. 15 also shows that the teeth on the ratchet gear 234 and the ratchet pawl 249 are saw-tooth shaped and cut on such a bias that the weight of the beam acting through the ratchet mechanism will tend to make the teeth engage with each other. The teeth will disengage and ratchet over each other if the support beam 205 is lifted. Lowering the beam requires operation of the handle 253 to release the pawl 249 from the gear 234. The handle is operated by being rotated about a spindle and the distal end of the push rod is mounted eccentrically to the handle spindle, for example by means of a second clevis coupled to an eccentric pin (not shown).

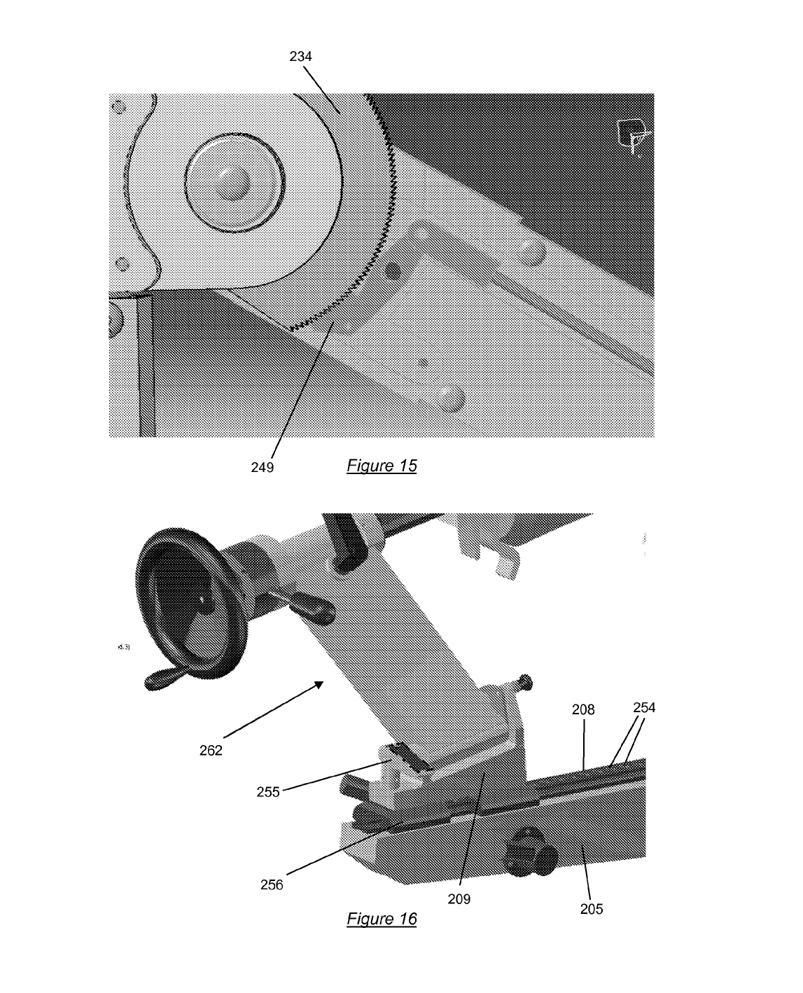

As shown in FIG. 16, the support beam 205 includes a track 208 on its upper surface and a carriage including a chassis 209 and a superstructure 262 is mounted to move along the track 208. As will be discussed later, the superstructure 262 is designed to engage a foot receptacle and this to hold the operative leg in position. The track 208 includes a plurality of countersunk recesses 254 distributed along its length and the chassis 209 is furnished with a cam lever 255 that raises and lowers a pin (not shown) so that it can engage the recesses, thus to prevent movement of the chassis 209 along the track 208.

Because it has been discovered that tight tolerances will not be needed, the track 208 can be a low-beam traveller track of the kind used on sailboats and the chassis 209 can be mounted on sailboat travellers 256 with recirculating ball bearings. Suitable tracks and travellers are manufactured by Harken, Inc., and by other sailboat hardware manufacturers. When subjected to a thrust load transverse to the track, these travellers will tip in a rocking motion by an angle of 2° to 5° or more, and this may result in transverse movement of the point at which the foot receptacle is attached by at least 10 mm, sometimes 20 mm or even 25 mm or more. To take care of the misalignment that occurs between the recesses 254 in the track 208 and the pin that is raised and lowered by the cam lever 255, a number of things can be done. The first and simplest is to enlarge the recesses 254 laterally, but this requires machining of all the recesses 254. An alternative is to fix the pin against rotation, for example by a key and keyway, and then to taper the pin laterally so that it is less wide at its base than it is thick. The degree of enlargement of the recesses or of tapering of the pin will depend upon the circumstances.

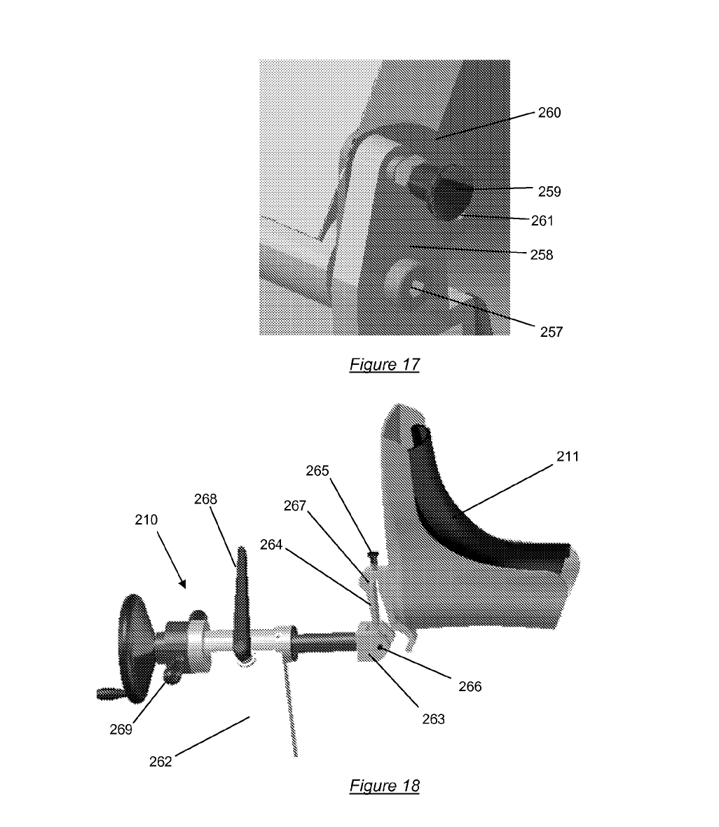

As shown in FIG. 16, and in greater detail in FIG. 17, the superstructure 262 is pivotally mounted on the chassis 209 about a longitudinal axis 257. The chassis 209 includes an upstand 258 with a retractable sprung peg 259 mounted in it. The head of the peg 259 can be pulled to retract it, but as soon as it is let go, it returns to its extended position. The superstructure 262 carries a locating bracket 260 in the shape of a sector of a circle and this bracket has two holes 261 (only one of which can be seen) with which the retractable peg 259 can engage. This enables the superstructure to be fixed in two positions, one in which its centre of mass (and that of the carriage) lies to one side of the contact between the traveller and the track and a second in which its centre of mass (and that of the carriage) lies to the other side. This reconfiguration allows the accessory to be use for both the left and the right hip, and is such as to cause the traveller 256 to tip to one side or the other depending upon the position of the superstructure 262.

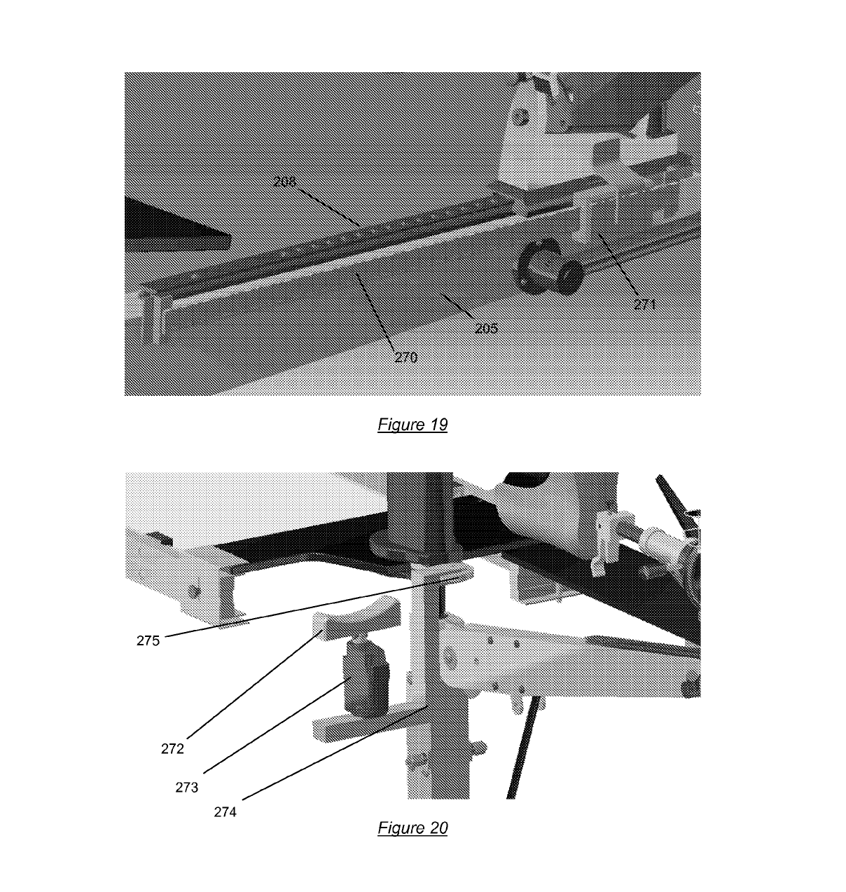

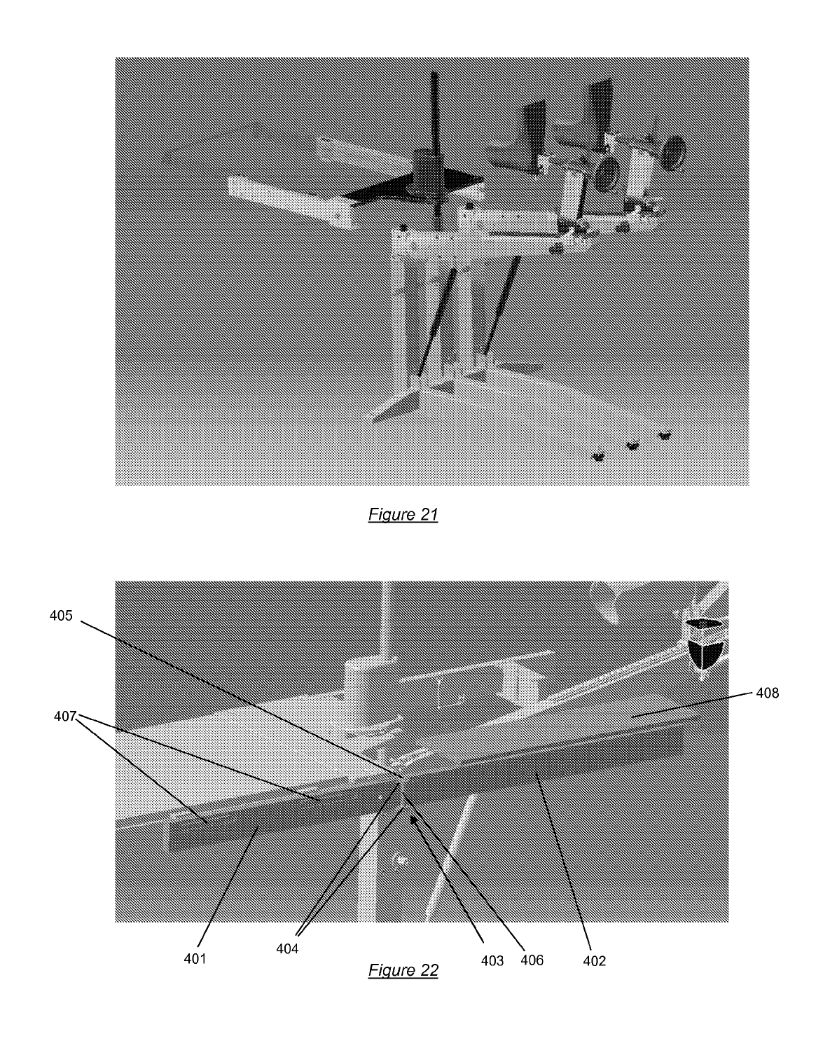

FIG. 18 shows the mechanism for attaching the boot 211 to the end of the lead screw mechanism of the carriage superstructure 262. The end of the lead screw mechanism carries a clevis 263 with a clevis pin 266. Attached to the boot is a retention element 264 having an open channel, wherein the size of the channel increases from the closed end to the open end, so as to facilitate receipt of the clevis pin into the open end of the channel, whereupon the pin is guided along channel to the closed end. The closed end of the channel includes a retractable sprung peg 265, similar to the peg 259 in the carriage upstand 258. The clevis pin 266 pushes the retractable sprung peg 265 out of the way and then seats in a lateral terminal recess 267 at the closed end of the channel, whereupon the retractable sprung peg 265 returns to its extended position and latches the clevis pin 266 into the lateral terminal recess 267. In this position, the boot 211 can be articulated about the clevis pin 266 to provide dorsiflexion and plantar flexion of the foot.

The lead screw actuator is used in the conventional way to advancing and retract the clevis 263 and pin 266 in the direction of the track 208. As shown, the lead screw is driven by a hand wheel and the clevis 263 is connected to the lead screw nut. The clevis as also rotatable relative to the lead screw mechanism about an axis substantially aligned with the predetermined path, thus allowing the limb receptacle to rotate relative to the limb support, and can be locked using a mechanism similar to that used to lock the bearing tube 233, the handle 268 for which can be seen in FIG. 18, together with the handles 269 used to rotate the clevis to achieve external or internal rotation of the leg.

FIG. 19 shows a position indicator mechanism. A scale 270 comprising a series of equally spaced, optically or magnetically detectable markers is attached to the support beam 205 so as to lie alongside the track 208. A display device 271 is attached to the carriage and includes an optical or magnetic detector to detect the markers and a means for counting the number of markers past which it has moved and to display position information indicative of that number. The scale and display device can operate in exactly the same way as a set of digital Vernier callipers. The count maintained by the counting means can be reset at any position of the carriage, by means of a reset button (not shown).

FIG. 20 shows a femoral lift pad 272, which can be used to raise the proximal end of the severed femur to provide access to the femoral canal. As illustrated, the pad 272 is mounted on a battery-powered linear actuator 273 that can raise and lower the pad, which in turn stands on a lateral extension of an angle bracket 274. The top of the angle bracket 274 swivels on an extension piece 275 that is slotted into a slot in the thrust spacer 212 and through which the reaction post 204 passes. The angle bracket can be swung over to the other side of the post 204 either by being disconnected from the extension piece 275 or by raising the thrust spacer on the reaction post and swinging it around on the extension piece 275. Although a motorised pad 275 is shown, it is also possible to use a manually movable pad or one that can be fixed in a plurality of vertical positions relative to the bracket 274. A telescoping bracket would serve that purpose. Alternatively, the pad 275 can be fixed and the limb support beam 205 dropped to apply an upwards force to the proximal femur.

In a different design, the femoral lift pad support structure could be fixed directly to the top of the vertical post so that it does not go up and down with the operating table. In this case it can be brought into effect by lowering the whole operating table and the patient using the normal controls of a typical modern operating table. This may gives a better angle with the broaches, impactors, etc.

As has already been discussed, the patient support plate 103 may be an integral feature of the operating table rather than a separate component. In either case, It may be fixed relative to the table or extendable from it.

The reaction post 204 can be constructed in two pieces, a first piece that extends up as far as the bearing tube 233, and a second piece that is screwed into the first.

With the equipment just described, an operating table can be prepared for surgery on a limb easily and quickly. The floor-standing accessory component 200 is positioned adjacent to the operating table and the notch on the patient support plate 103 is offered up to the guide channels 217 on the thrust spacer 212 to locate them relative to each other. If the patient support plate is on a separate table-mounted accessory component, then it can be offered up to the thrust spacer 212 as part of the process of attaching it to the side frame members 101, 102. If it is extendable relative to the table, however, it is easier to assemble it to the table and then to extend it towards the thrust spacer 212 of the floor-standing component.

Before the operation is performed, the patient has to be prepared, gowned, pre-medicated if necessary, sedated and anaesthetised. For a procedure involving the equipment presented here, this process will involve fitting the boot 211 to the foot of the operative leg. Velcro straps may be provided for this purpose, for example overlying a shaped carbon-fibre tongue insert 280 (FIG. 18) that is retained within the boot and provides a stable reaction surface for the application to traction to the leg via the dorsal surface of the foot. A venous thrombo-prophylaxis calf pump is also fitted.

The patient is wheeled into theatre and, in the case where the patient support plate 103 is offered up to the thrust spacer 212 as part of the process of attaching it to the side frame members 101, 102, the patient will be transferred from the trolley to the operating table by use of a board in the conventional way. This is facilitated by prior removal of the second, upper piece of the reaction post 204 so that the patient can be slid across into position, and the upper piece of the reaction post 204 subsequently screwed into place. Alternatively, if the patient support plate 103 is extendable relative to the table, however, the patient can moved onto the table before the patent support plate 103 and the thrust spacer 212 are approximated. Here, it is not necessary for the upper piece of the reaction post 204 to have been removed, and indeed the reaction post 204 can be a single piece.

Next, the boot 211 is attached to the lead screw mechanism 210. At this point, the lead screw mechanism, and the carriage upon which it is mounted, may be freely movable along the track 208, or it may have been fixed in a templated position. The boot is positioned so that the end of the open channel in the retention element 264 attached to its sole is over the clevis pin 266 at the free end of the channel. Owing to the shape of the channel, accurate alignment is not critical. The boot 211 is lowered, whereupon the clevis pin 266 is guided along channel to the closed end. The clevis pin 266 pushes the retractable sprung peg 265 out of the way and then seats in the lateral terminal recess 267 at the closed end of the channel, whereupon the retractable sprung peg 265 returns to its extended position and latches the clevis pin 266 into the lateral terminal recess 267. The clevis pin 266 is free to rotate in the lateral terminal recess 267 to allow dorsiflexion and plantar flexion of the foot. The passive, non-operative leg is strapped onto its support plate 105.

The default height of the femur pad, if used, is now set with reference to the patient's anatomy. Usually, there will be at least 30 mm of movement available, or 50 mm or more in some cases. The upper part of the reaction post 204, if it has been removed, would typically be replaced at this point. The lead screw chassis 209 is fixed in position, if necessary, with the patient's leg straight.

The incision site is exposed and a self-adhesive surgical drape is applied. As before, the incision site is determined using the anterior superior iliac spine as a reference. The leg is lifted slightly to slacken the muscle tone at the front of the thigh. Typically, the foot is raised by about 15 cm, by lifting the support beam 205 about its articulation 206. An incision is made close to the intermuscular space between the tensor fascia lata and the sartorius muscle. The fascia overlying the tensor fascia lata is then incised in line with the skin incision. The intermuscular interval is developed down to the hip capsule and an anterior capsulotomy is performed to aid in visualization and femoral mobilization.

Traction is applied to the base of the boot 211 using the lead screw mechanism 210, retracting the foot by about 10 mm to 20 mm. The surgeon makes a note of the muscle tone or the subjective amount of force applied to the hand-wheel to estimate the amount of traction applied. He also zeroes the display of the digital position display device 271 that is attached to the carriage.

With the traction applied the femoral neck osteotomy is performed with the applied traction helping complete, and opening, the osteotomy of the femoral neck. Once the final neck cut has been made at the preoperatively planned osteotomy level the foot is externally rotated to achieve, say, 45° of external rotation at the hip. This exposes the cut surface of the head aiding the insertion of a cork screw to remove the femoral head. Distraction of the leg is applied using the hand wheel and external rotation, using the rotation handles 269 on the lead screw mechanism 210.

With the femoral head removed, the acetabulum is prepared. Exposure can be helped by placing the leg in neutral rotation and abducting the limb towards the midline by swivelling the beam 205 about the reaction post 204.

Once the acetabular component is inserted, the traction is released and the leg is lowered to the floor using the pawl release handle 253 to release the pawl 249 from the gear wheel 234, allowing the beam 205 to be lowered against the upward restoring force of the gas strut 207. By swivelling the beam 205 about the reaction post 204, the leg is adducted by, for example, 12 cm at the foot towards the passive leg. Again, using the rotation handles 269 on the lead screw mechanism 210, the leg is positioned in 45° of external rotation at the knee to expose the proximal femur. In this position, the foot might be 180°-270° externally rotated. The femoral lift pad 272 is at this point progressively lifted to raise the proximal femur until the osteotomy plane can be reached through the skin incision.

A wedge of cancellous bone is removed from the cut end of the femur, creating an entry into the femoral canal. Broaching is then performed with progressive broach sizes, beginning with a smaller broach than the planned prosthesis. Once the final broach is in place, a process of trial reduction is performed. The appropriate neck trial is placed in a hole on the upper face of the broach. An appropriate femoral head trial is selected and assembled for trial reduction. The process of trial reduction involves manipulation of the beam 205 to lift the leg to a neutral position applying traction and internally rotate the foot, knee and hip using the rotation handles 269. After the components are selected, the hip is dislocated by applying traction and external rotation, as described before, and a bone hook around the trial neck. The trial components are removed, along with the broach.

The appropriate femoral stem is chosen and placed into the prepared broach cavity. The femoral stem is impacted and another trial reduction can be performed with the final femoral stem and the femoral head trial. At this point, the surgeon uses the hand wheel to apply a subjectively similar amount of traction as was applied when the display of the digital positioning device 272 was zeroed, and checks the reading on the device. If the reading shows a figure greater than +/−10 mm, or such figure as the surgeon may select, different component may have to be chosen. With this done, the chosen femoral head component is placed onto the taper of the femoral stem and secured using an impactor or, in the case of a ceramic head, by hand. The hip is reduced and a final check of leg length, and hip motion and stability should be made. The incision is then closed and the procedure is complete. All implant positions are checked using image intensification.

A bilateral version of the floor-standing component may be constructed as shown in FIG. 21. The base is larger, there are three box section uprights, each with a post within. The centre post is a reaction post that supports the thrust spacer as before; the two outer posts are shorter and provide a support for left and right articulating limb support beams. The carriage superstructures are fixed in position relative to the chassis because the lateral offset is already provided by the use of the outer posts, offset from the central reaction post. In all other respects, this version is the same as the handed version previously described. A semi-bilateral version in which a second, similar boot 211 is used, together with a retention feature for it on the passive leg support is also contemplated. This retention feature can be fixed to the passive leg support or be on a carriage that slides along a track and can be locked to it, in the same was as with the boot for the operative leg. There is no need for this carriage to include a lead screw mechanism, however, or to allow rotation of the foot.

The handed table-mounted component can also be improved for greater convenience when a bilateral hip operation is to be performed. For example, the table-mounted component 100 of FIG. 1 is shown set up for an operation on the right hip joint. If it is to be used in a bilateral operation, it must be reconfigured when the operation on the right hip joint is complete. This involves swapping the side frame members 101, 102, together with their hangers 106, so that the longer of the two is now on the right side and the other way up, and reinstalling the patient support plate 103 the other way up too, so that the cut-away 109 is on the left side. The passive leg support plate 105 also needs to be moved and reinstalled in a different position on the longer side frame member 102.

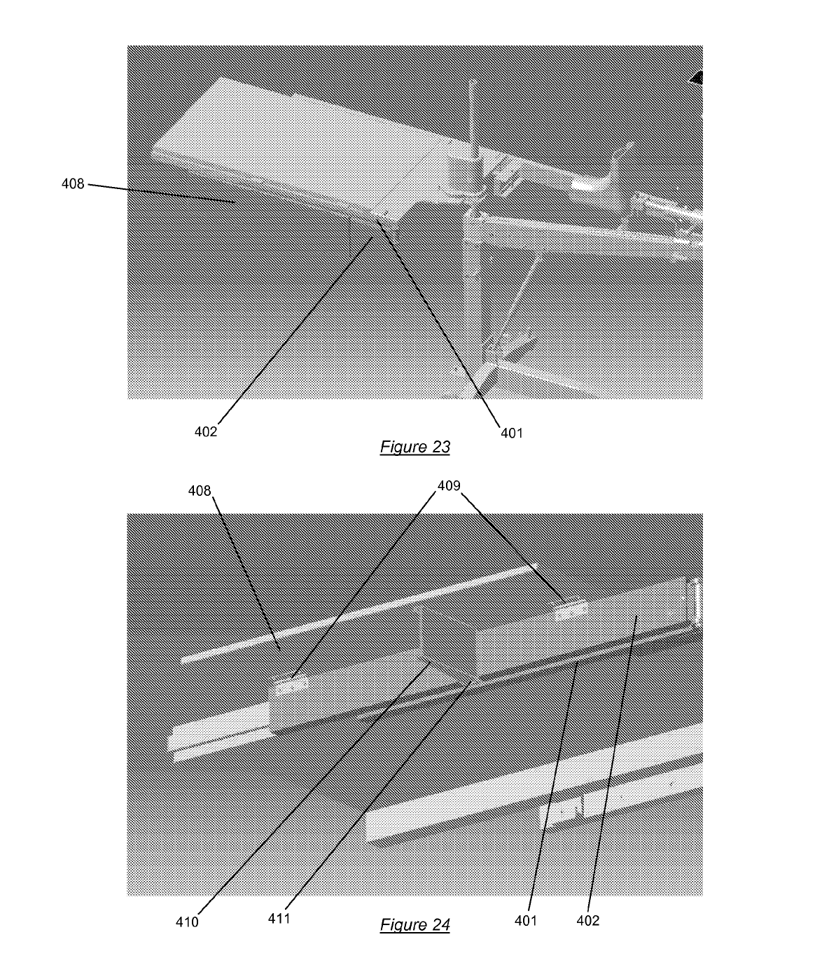

FIGS. 22-24 illustrate an improved side frame member that can be stowed when not in use. One of these can be provided on each side of the table-mounted component so that the left side member is deployed and the right side member stowed when the right hip is being operated upon, and vice versa. As can be seen from FIGS. 22-24, each side frame member 400 now includes a stationary portion 401 and a movable portion 402, attached to the stationary portion at a vertical hinge 403. The hinge is formed by complementary lugs 404 on the stationary and movable portions 401, 402 and a vertical bolt 405 that passes through the lugs 404 and is provided with a lock not such as a nylok nut on its leading end. The shaft of the bolt passes through a sleeve 406 that provides internal support to the lugs 404. The movable portion 402 hinges relative to the stationary portion 401 from the deployed position shown in FIG. 22 to the stowed position shown in FIG. 23. Various latches, detents or other retention features (not shown) may be provided to releasably retain the movable portion in one or other of these positions, or both.

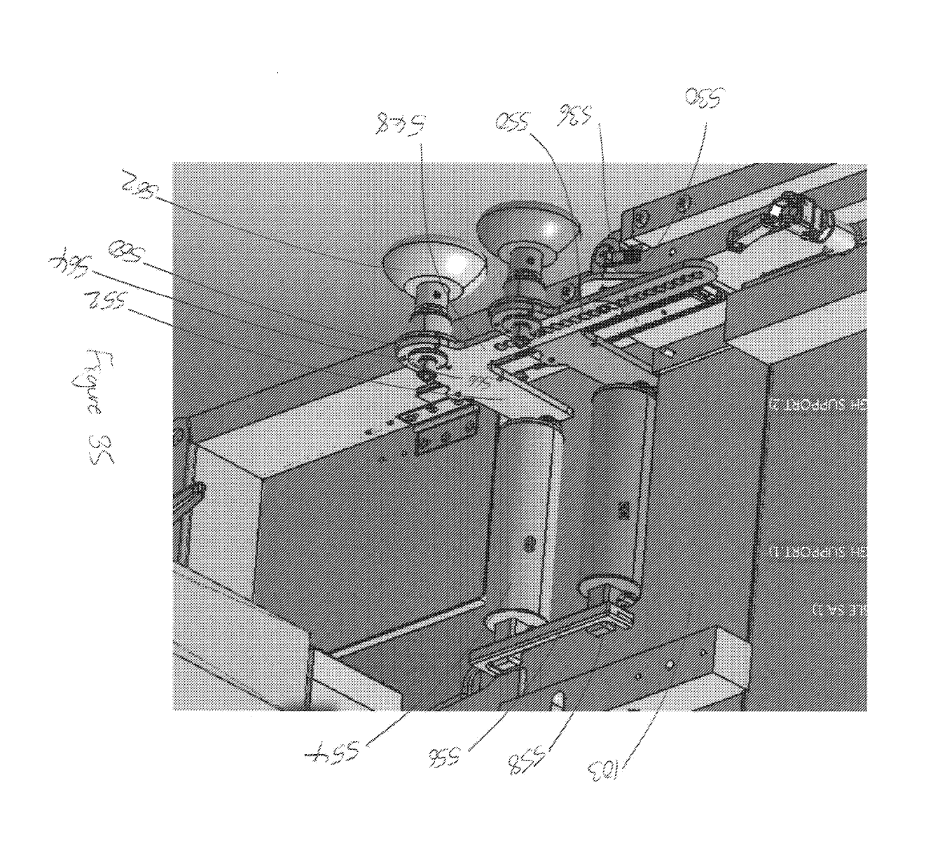

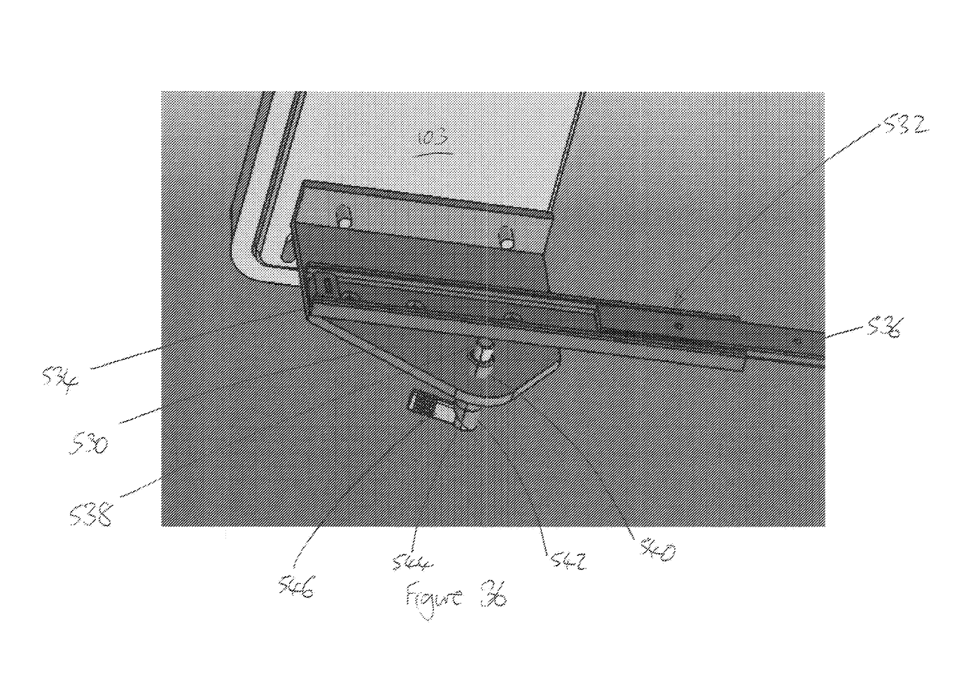

FIGS. 31-34 illustrate one mechanism for retaining the folding side frame member in the deployed position. Here, the distal end of the movable portion 402 is cut away to provide access to an overcentred toggle clamp 520. Suitable toggle clamps are available from Wixroyd International Ltd, Cranleigh, Surrey. For example, the 4170.W0001 hook type toggle clamp will provide 45 mm of travel, or the 4170.W003 hook type toggle clamp will provide 98 mm of travel. Attached to the toggle clamp, for example to the hook 522 if a hook type toggle clamp is used, is a connecting rod (not shown), which passes alongside the movable portion 402 and terminates in a connection to a roller chain 524, schematically illustrated in FIGS. 32-34. This roller chain wraps around the bolt or spindle 405 and terminates in a fixed connection 526 to the fixed part 401. Movement of the movable part 402 from its stowed to its deployed position introduces slack into the chain 524 and this slack can be taken up by the toggle clamp 520, operation of which therefore has the effect of locking the movable part 402 into its deployed position. It would of course be possible to reverse this mechanism and have the toggle clamp on the fixed part 401 with the chain attached to the movable part instead.

The stationary portion 401 includes a pair of countersunk slots 407, each of which is designed for two or more bolts to pass through and be bolted into hangers (not shown) that can be similar to the hangers 106 of FIG. 3, although these can be simplified by the omission of the bottom part since there is no need for these hangers to be reversible. The slots 407 allow the hangers to be positioned where needed on the side rail 310 of the operating table 300.

Each of the movable portions 402 has its own leg support plate 408 and this plate is movable from the stowed position shown in FIG. 23 to the deployed position shown in FIGS. 22 and 24. The leg support plate 408 is shown mounted at its upper edge to the upper edge of the movable portion 402 by a pair of spaced door hinges 409, although a piano hinges or other kinds of hinge would do just as well. The stowed position of FIG. 23 is one in which the leg support plate 408 simply hangs down by the side of the movable portion 402. The deployed position is on in which the leg support plate 408 has been hinged upward by 90°. To keep the leg support plate in this position, a swing bracket 410 is carried by the movable portion 402, mounted on a vertical pivot or pivots 411. The swing bracket 410 is able to swing out by 90° and locates the underside of the leg support plate 408 by means of a pin and a cooperating recess (not shown).

With side frame members of this improved design, the process of preparing the patient for surgery can be substantially improved, even when bilateral surgery is not needed. Having both side frame members and their leg support plates deployed at the outset enables the patient to be moved from a trolley to the operating table so that he ends up with one leg on each leg support plate. This is done before the floor-standing component is offered up to the table-mounted component and typically the patient will already be wearing the boot on the foot of the operative leg. Once the floor-standing component has been wheeled into place and coupled to the table-mounted component, the patient is repositioned, the boot is coupled to the carriage on the limb support and the leg support plate and side frame member upon which the operative leg had been resting are stowed. It is a significant advantage to be able to reposition the patient while both legs are supported, especially because it reduces the risk of injury to those who are responsible for the repositioning.

These side frame members also permit the assembly to be reconfigured during bilateral surgery by stowing one of the side frame members and deploying the other, and then just reversing the patient support plate 103. A further improvement uses a symmetrical patient support plate with bilateral cut-aways, so there is no need to reverse this component either. FIGS. 25 and 26 illustrate just such a symmetrical patient support plate together with an improved femoral lift pad.

FIG. 25 shows the patient support plate 413 with bilateral cut-aways 419. Each cut-away 419 is rectangular as opposed to the profiled cut-aways 109 of the patient support plate 103 previously described. This is to allow the use of the new femoral support pad. FIG. 25 also shows a rail 412 attached to the base of the patent support plate 413. There is a corresponding rail (not shown) on the other side. The femoral support pad now takes the form of an eccentrically mounted roller 414.

As is best seen in FIG. 26, a mounting bracket 415 is clamped to the base of the stationary portion 401 of the side frame member by means of an adjustment knob 416. This knob 416 is attached to a threaded shaft (not shown) that screws into the stationary portion 401. The mounting bracket 415 has a slot 417 to allow fore and aft movement of the bracket 415. It is to accommodate this fore and aft movement that the cut-aways 419 are made rectangular. At the front of the mounting bracket 415 is an extension 418 to which one end of the roller 414 is eccentrically mounted by means of a spindle 420, which passes right through the roller 414 and projects from the other end to be received between the rail 412 and the underside of the patient support plate 413. The roller is in two parts, a body 421 and a cap 422. The cap 422 and the body 421 can collapse telescopically to a limited extent, but biased by an internal spring (not shown) into the expanded state illustrated. This enables the provision of angular positioning features (not shown) on the bracket extension 418 and the flat end of the roller body 421 by means of which the angular position of the roller can be set. An example of such angular positioning features would be a series of regularly angularly spaced countersunk holes 422 in the flat end of the roller body 421 and a locating pin on the bracket extension 418.

The adjustment knob 416, slot 417 and the eccentric mounting of the roller 414 on the spindle 420, together with the angular positioning features, enable the position of the femoral pad defined by the roller 414 to be set both horizontally and vertically, as desired. Thus, it can be used to raise the proximal end of the severed femur to provide access to the femoral canal. The roller that is on the non-operative side may be stowed in a retracted position or may be positioned flush with the upper surface of the patient support plate 413.

FIGS. 35 and 36 illustrate an alternative to the femoral lift pad of FIGS. 25 and 26. As is best seen in FIG. 36, an angle bracket 530 is mounted to the underside of the patient support plate 103. The angle bracket carries a slider mechanism 532 having a stationary track 534 fixed to the angle bracket 530 and a movable portion 536. It also has a spring-loaded pin 538, biased toward the position shown in FIG. 36, in which it projects from a boss 540 in the angle bracket 530. On the other side of the angle bracket 530, the pin 538 projects from a second boss 542 with an angled cam surface 544. The angled cam surface 544 cooperates with a cranked portion 546 of the pin 538, so that rotation of the pin causes the pin to be retracted into the first boss 540.

As shown in FIG. 35, to the movable portion 536 of the slider mechanism is attached a mounting bracket 548. A series of apertures 550 in the mounting bracket allow the spring-loaded pin 538 to retain the bracket in a number of longitudinal positions relative to the patient support plate 103. Two such positions are shown in FIG. 35. At the front of the mounting bracket 548 is an extension 552 to which one end of a roller 554 is eccentrically mounted by means of a spindle, which passes right through the roller 554 and projects from the other end to be received in a lug 558, positioned to slide between a rail 556 and the underside of the patient support plate 103.

A second extension 560 of the mounting bracket 548 houses a rotatable control knob 562, rotation of which will turn a pulley 564 mounted on a common spindle 566. A belt (not shown) links this pulley to a second pulley on the roller spindle, so that rotation of the control knob 562 also rotates the roller 554 about its eccentric mount. The pulley 564 that rotates with the knob 562 is typically one third the diameter of that on the roller spindle, and this, together with friction in the rotation of the knob 562 may be enough to retain the roller in the desired angular position. Alternatively, a ratchet mechanism or sprag clutch could be used to achieve the desired effect.

1. An operating table accessory for use during surgery on a limb, comprising:
a component to be mounted on an operating table and including a patient support;
a floor-standing component including an articulated limb support; and
cooperating locating features on the two components, adapted to locate the components relative to each other such that with the patient support supporting at least some of the weight of the patient, the articulated limb support is properly positioned to support and manipulate the limb;
the cooperating locating features being so configured as to allow the table to be tilted relative to the floor-standing component while continuing to locate the components relative to each other.

2. The operating table accessory of claim 1, in which:
one component comprises a first part having a notch as a locating feature;
the other component comprises a second part having a pair of outwardly facing guide channels on either side as a locating feature, each guide channel having an outwardly facing base surface;
the notch and the guide channels are adapted to locate the two components relative to each other by receipt of the second part into the notch and by receipt of the margins of the first part adjacent to the sides of the notch into respective guide channels; and
the guide channels and the margins of the first part adjacent to the sides of the notch are so shaped as to allow the two parts to tilt relative to one another, thus allowing the table to be tilted relative to the floor-standing component while continuing to locate the components relative to each other.

3. The operating table accessory of claim 2, in which the first part is a part of the table-mounted component and the second part is a part of the floor-standing component.

4. The operating table accessory of claim 1, in which the floor-standing component comprises:
a substantially vertical reaction post; and
a thrust element that can be mounted on the reaction post.

5. The operating table accessory of claim 4, in which the thrust element is a thrust spacer having a vertical bore for sliding receipt of the reaction post and a thrust surface horizontally spaced from the vertical bore.

6. The operating table accessory of claim 4, in which:
the patient support has a notch as a locating feature;
the thrust element has a pair of outwardly facing guide channels on either side as a locating feature, each guide channel having an outwardly facing base surface;
the notch and the guide channels are adapted to locate the two components relative to each other by receipt of the thrust element into the notch and by receipt of the margins of the patient support adjacent to the sides of the notch into respective guide channels; and
the guide channels and the margins of the patient support adjacent to the sides of the notch are so shaped as to allow the patient support and the thrust element to tilt relative to one another, thus allowing the table to be tilted relative to the floor-standing component while continuing to locate the components relative to each other.

7. The operating table accessory according to claim 4, in which the thrust element is adapted to slide up and down the reaction post, thus allowing the table to be raised and lowered relative to the floor-standing component while the locating features continue to locate the components relative to each other.

8. The operating table accessory of claim 6, in which:
the thrust element is a thrust spacer having upper and lower sections and a vertical bore for sliding receipt of the reaction post;
the upper section has a thrust surface horizontally spaced from the vertical bore; and
the lower section has the guide channels on either side.

9. The operating table accessory of claim 6, in which the patient support and the thrust element are radiolucent.

10. The operating table accessory of claim 2, in which the said margins are substantially flat and the guide channels are crowned.

11. The operating table accessory of claim 10, in which the guide channels are crowned on both their upper and lower surfaces.

12. The operating table accessory of claim 2, in which the sides of the notch and the base surfaces of the guide channels are adapted to cooperate to constrain relative rotation between the first part or patient support and the second part or thrust element, as the case may be, about a vertical axis.

13. The operating table accessory of claim 12 in which:
the sides of the notch are substantially straight; and
the base surfaces of the guide channels are substantially straight; and
the angle between the sides of the notch is substantially equal to the angle between the base surfaces of the guide channels.

14. The operating table accessory of claim 13 in which the sides of the notch are substantially parallel and the base surfaces of the guide channels are substantially parallel.

15.-61. (canceled)

62. Operating room equipment for use during surgery on a limb, comprising:
an operating table;
a floor-standing accessory including an articulated limb support; and
cooperating locating features on the table and the accessory, adapted to locate them relative to each other such that with the operating table supporting the weight of the patient, the articulated limb support is properly positioned to support and manipulate the limb;
the cooperating locating features being so configured as to allow the table to be tilted relative to the accessory while continuing to locate the table and the accessory relative to each other.

63.-68. (canceled)

69. A method of preparing an operating table for surgery on a limb, comprising:
positioning a floor-standing accessory including an articulated limb support adjacent to the operating table; and
offering a locating feature on the table up to a cooperating locating feature on the floor-standing accessory, to locate them relative to each other such that with the table supporting the weight of the patient, the articulated limb support is properly positioned to support and manipulate the limb;
the cooperating locating features being so configured as to allow the table to be tilted relative to the floor-standing component while continuing to locate the components relative to each other.

70. The method of claim 69, further comprising mounting an accessory component including a patient support on the table, in which the locating feature on the table is a locating feature of the table-mounted accessory component.

71. The method of claim 70, in which mounting the accessory component on the table involves offering the locating feature of the table-mounted accessory component up to the cooperating locating feature on the floor-standing accessory.

72. The method of claim 69 in which the table has mounted on it an extendable accessory component including a patient support and the locating feature on the table is offered up to the cooperating locating feature on the floor-standing accessory by extending the extendable accessory component.

73. The method of claim 72, in which:
the extendable accessory component has a notch as a locating feature;
the floor-standing accessory comprises a locating part having a pair of outwardly facing guide channels on either side as a locating feature, each guide channel having an outwardly facing base surface;
the notch and the guide channels are offered up to one another by receiving the locating part into the notch and by receiving the margins of the extendable accessory component adjacent to the sides of the notch into respective guide channels; and
the guide channels and the margins of the patient support adjacent to the sides of the notch are so shaped as to allow the patient support and the thrust element to tilt relative to one another, thus allowing the table to be tilted relative to the floor-standing component while continuing to locate the components relative to each other.

74. The method of claim 73, in which:
the floor-standing component comprises:
a substantially vertical reaction post; and
a thrust element that can be mounted on the reaction post; and
the thrust element is the locating part.
